(19) United States
(12) Patent Application Publication
(10) Pub. No.: US 2015/0279426 A1
(43) Pub. Date: Oct. 1, 2015

(54) Learning Environment Systems and Methods

(71) Applicant: AltSchool, PBC, San Francisco, CA (US)

(72) Inventors: Slade Maurer, San Francisco, CA (US); Jay Ho, Oakland, CA (US); Michael Kim, Walnut Creek, CA (US); Jeremy Shute, Brooklyn, NY (US)

(73) Assignee: AltSchool, PBC, San Francisco, CA (US)

(21) Appl. No.: 14/668,757

(22) Filed: Mar. 25, 2015

Related U.S. Application Data
(60) Provisional application No. 61/970,814, filed on Mar. 26, 2014.
(60) Provisional application No. 61/970,815, filed on Mar. 26, 2014.
(60) Provisional application No. 61/970,819, filed on Mar. 26, 2014.
(60) Provisional application No. 61/985,959, filed on Apr. 29, 2014.
(60) Provisional application No. 62/069,086, filed on Oct. 27, 2014.

(51) Int. Cl. G11B 27/10

(52) U.S. Cl. CPC G11B 27/10

(57) ABSTRACT

A system includes one or more devices for use in a learning environment that transmit information about the learning environment to a computing system. A recording device for use in the learning environment includes a camera, a processing device, and a storage device. The processing device is configured to process each of a plurality of video files including video data captured by the camera to generate information about which of the plurality of video files satisfy a particular characteristic. The recording device is configured to transmit the information about which of the plurality of video files satisfy the particular characteristic to the computing system, and is configured to transmit a particular video file of the plurality of video files in response to a download request for the particular video file. Wearable devices are wearable by students in the learning environment and transmit signals to provide information about the students.

### CROSS-REFERENCE TO RELATED PATENT APPLICATIONS

This application claims priority from U.S. Provisional Patent App. Ser. No. 61/970,814, filed Mar. 26, 2014, and also claims priority from U.S. Provisional Patent App. Ser. No. 61/970,815, filed Mar. 26, 2014, and also claims priority from U.S. Provisional Patent App. Ser. No. 61/970,819, filed Mar. 26, 2014, and also claims priority from U.S. Provisional Patent App. Ser. No. 61/985,959, filed Apr. 29, 2014, and also claims priority from U.S. Provisional Patent App. Ser. No. 62/069,086, filed Oct. 27, 2014, the entire contents of each of which are incorporated by reference herein.

### FIELD

Embodiments of the present invention relate generally to learning environment systems and methods and, in specific embodiments, to systems and methods using devices for the monitoring, analyzing, and reporting of events occurring in a learning environment.

### BACKGROUND

In a learning environment, such as a classroom, a lecture hall, a home school, a workplace, an office, or the like, there are many factors that impact the learning experience of students and the ability of teachers and administrators to perform their duties. Students, teachers, and administrators, as well as parents and guardians of the students, often all affect the learning experience. Having a well-educated populace is generally considered important for the functioning of society, the economy, and future innovation.

### SUMMARY OF THE DISCLOSURE

Various systems and methods in accordance with embodiments allow for obtaining information about a learning environment and for analyzing the obtained information. A system in accordance with an embodiment includes a recording device having a camera, a processing device, and a storage device. In some embodiments, the processing device is configured to process each of a plurality of video files including video data captured by the camera to generate information about which of the plurality of video files satisfy a particular characteristic, and is configured to store the plurality of video files in the storage device. In some embodiments, the particular characteristic may be, for example, whether there is motion in a video of the video file, whether there is a person in the video of the video file, whether there is a particular person in the video of the video file, whether there are more than a specified number of people in the video of the video file, whether there is a person with a particular emotional state in the video of the video file, or the like. In various embodiments, the recording device is configured to transmit the information about which of the plurality of video files satisfy the particular characteristic to a computing system, and is configured to transmit a particular video file of the plurality of video files in response to a download request for the particular video file. In some embodiments, each video file of the plurality of video files satisfies the particular characteristic if there is motion in a video of the video file.

In various embodiments, the recording device further includes a second camera and a second processing device for processing video data from the second camera, and a housing for housing the processing device and the second processing device. In some embodiments, the recording device further includes a wireless transceiver for receiving wireless signals from one or more wearable devices. In some embodiments, the recording device is configured to transmit information based on the wireless signals received from the one or more wearable devices to the computing system over a network. Also, in some embodiments, the recording device is configured to determine a distance from the recording device to each of the one or more wearable devices based on the wireless signals received from the one or more wearable devices.

In various embodiments, the recording device further includes a rotatable mount on which the camera is mounted, and a microphone mounted on the rotatable mount for providing audio data to the processing device. In some embodiments, the recording device further includes a second camera and a third camera, and the camera, the second camera, and the third camera are positionable to capture video for at least 174 degrees of area.

In various embodiments, the system further includes an audio recording device including a printed circuit board, a plurality of microphones connected to the printed circuit board, and a processor connected to the printed circuit board for processing audio data generated from audio signals produced by the plurality of microphones. In some embodiments, the audio recording device is configured to provide audio files processed by the processor to the computing system over a network. In some embodiments, the computing system includes a server. Also, in some embodiments, the system further includes a second audio recording device that is configured to provide second audio files to the computing system, and a universal serial bus hub for connecting the audio recording device and the second audio recording device to a computing device. In some embodiments, the system further includes the computing system that is configured to track a movement of a person based on the audio files and the second audio files.

In various embodiments, the system further includes an environment sensor for sensing an environmental parameter related to an environment in which the recording device is located, and for providing information about the environmental parameter to the computing system. In some embodiments, the environmental parameter is a temperature, an amount of light, a humidity reading, or the like. In various embodiments, the system further includes a plurality of wearable devices that each include a processing device and a wireless transceiver. In some embodiments, the plurality of wearable devices are configured to form a mesh network with each other and to transmit signals to the recording device.

In some embodiments, the system further includes the computing system that is configured to prioritize video files from among the plurality of video files for download from the recording device based at least partially on the information about which of the plurality of video files satisfy the particular characteristic. In some embodiments, the computing system includes a server that is configured to transfer one or more video files to a computing and storage system over a network upon receiving a hypertext transfer protocol (HTTP) POST command from a user device. In various embodiments, the computing system is configured to perform facial recognition on a video file received from the recording device to determine an emotional state of individuals in a video of the video file. In some embodiments, the processing device is configured to segment the video data captured by the camera into the plurality of video files that are each of a same time length. Also, in some embodiments, the processing device is configured to perform facial recognition on each of the plurality of video files and to tag one or more of the plurality of video files based on a result of the facial recognition.

A method in accordance with an embodiment includes obtaining video files by a recording device, generating a video motion list by the recording device indicating which of the video files include videos with motion, transmitting the video motion list to a server, and selecting, by the server, one or more of the video files to download from the recording device based at least partially on the video motion list. In some embodiments, the method further includes performing facial recognition on the video files by the recording device, and tagging the video files by the recording device based at least partially on a result of the facial recognition. Also, in some embodiments, the method further includes downloading, by the server, the selected one or more video files from the recording device.

### BRIEF DESCRIPTION OF THE FIGURES

FIG. 1 is a block diagram of a system for assisting in various functions related to an environment, such as a learning or work environment, according to an exemplary embodiment.

FIG. 2 illustrates an example configuration of a recording device in accordance with an embodiment that is connected to a network and a power supply.

FIG. 3 illustrates a flowchart of a process in accordance with an embodiment of prioritizing video files for download.

FIG. 4 illustrates a block diagram of a processing circuit of a remote server in accordance with an embodiment.

FIG. 5 illustrates an example configuration of an audio recording device in accordance with an embodiment.

FIG. 6 is a block diagram of an example configuration of a recording device configured to capture video and audio, according to an exemplary embodiment.

FIG. 7 illustrates a block diagram of a wearable device in accordance with an embodiment.

FIG. 8 illustrates an interaction among wearable devices and a teacher computing device in accordance with an embodiment.

FIG. 9 illustrates a flowchart of a method in accordance with an embodiment.

FIG. 10 is a flowchart of a method in accordance with an embodiment for monitoring and gaining insight into student performance and providing recommendations based on the student performance.

FIG. 11 is a flowchart of a method in accordance with an embodiment.

### DETAILED DESCRIPTION OF EXEMPLARY EMBODIMENTS

Referring generally to the figures, systems and methods are described for assisting in various functions related to a learning environment, such as a classroom, a lecture hall, a home school, a workplace, an office, or the like. Systems in accordance with various embodiments include cameras, microphones, sensors, wearable devices, computers, and other input devices for capturing motion, audio, and events that happen in the learning environment. In various embodiments of a system, captured audio and video are provided to a remote server, and the system performs a method for determining how to provide the captured audio and video to the remote server. For example, in some embodiments, audio and video files are prioritized based on contents of the files, such as whether motion was detected in a video file, whether audio was detected in the audio file, or the like. A method in accordance with various embodiments selects which files to upload to the remote server, or in what order to upload the files, based on a prioritization of the files.

In various embodiments, the remote server processes the files and provides the files to a plurality of user devices, such as computers, laptops, tablets, or the like, of teachers, parents, administrators, or other users. By capturing audio and video in the learning environment, the files may be reviewed later during a discussion to analyze events that have taken place in the learning environment. Further, in various embodiments, the files are used in post-processing to build inferences for future data mining and for analysis, such as processing historical data to determine future actions to be taken. Capturing learning moments provides the ability to, for example, increase transparency, enable reflection, and provide valuable documentation for communication among teachers, students, and parents.

Various systems and methods described in the present disclosure allow for observing, monitoring, and analyzing various aspects of a learning environment and actions occurring in a learning environment. Some systems include environment sensors for monitoring a state of the learning environment, such as temperature or light sensors. Some systems include wearable devices that can be worn by students to monitor student location, actions, and other events. Also, some systems allow for monitoring student computing devices, such as computers, tablets, smart phones, and the like to track studying efforts, test taking, and the like, and allow for controlling content sent to each student computing device based on the monitored data. Some systems and methods disclosed herein allow for determining an effectiveness of a teacher or of tools in a learning environment, and for identifying distractions or disruptive behavior in the learning environment, observing a performance of one or more students or teachers, monitoring activity, and providing other functions that can be used to assist in an educational process. In other words, various embodiments of systems and methods disclosed herein can be used to improve educational outcomes and/or provide for user experience research.

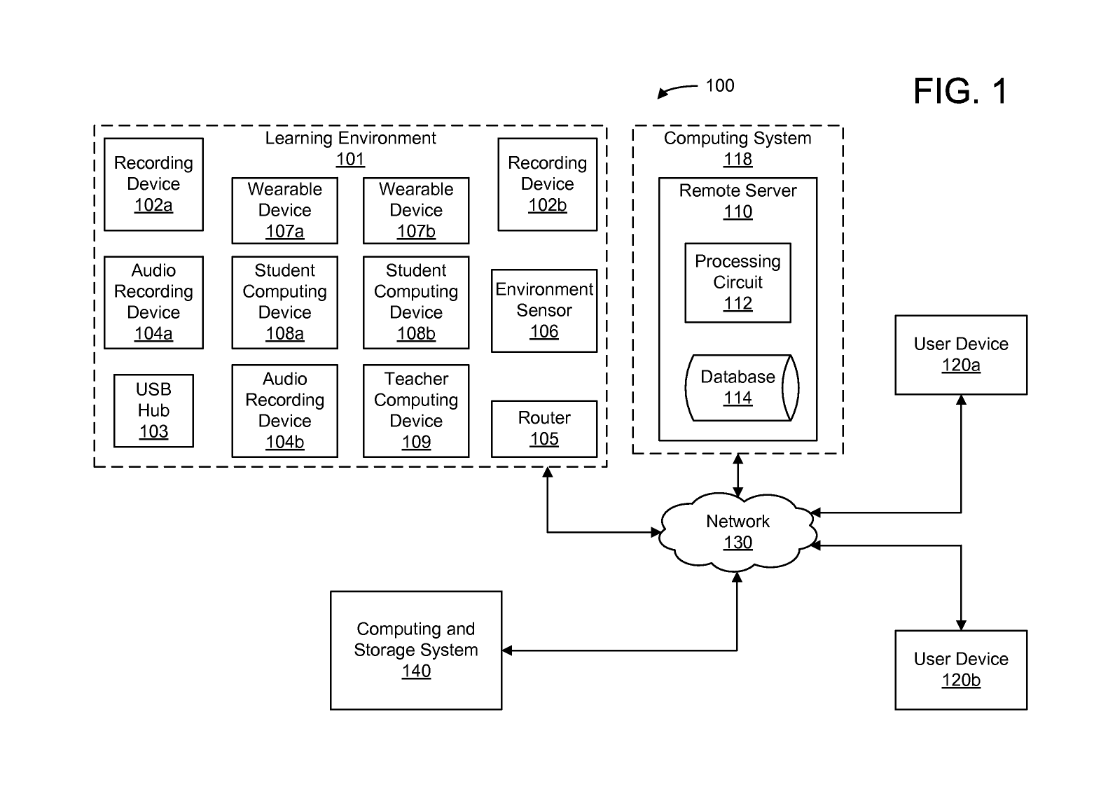

FIG. 1 illustrates a system 100 in accordance with an embodiment that can be used for a learning environment 101. In various embodiments, the system 100 includes a recording device 102a, a recording device 102b, a universal serial bus (USB) hub 103, an audio recording device 104a, an audio recording device 104b, a router 105, an environment sensor 106, a wearable device 107a, a wearable device 107b, a student computing device 108a, a student computing device 108b, and a teacher computing device 109 that can be located within the learning environment 101. In some embodiments, the system 100 further includes a computing system 118, a user device 120a, a user device 120b, a network 130, and a computing and storage system 140. In some embodiments, the computing system 118 includes a remote server 110 having a processing circuit 112 and a database 114. In some embodiments, the computing system 118 includes the computing and storage system 140 and/or other additional computing devices and storage devices that may be connected over a network.

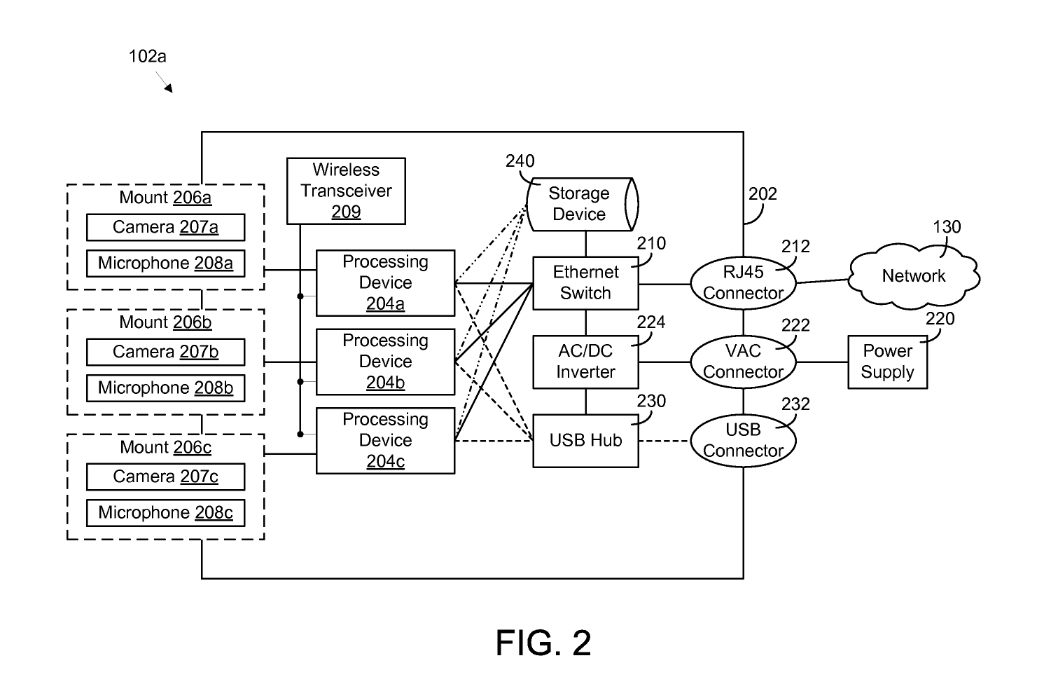

While two recording devices 102a and 102b are shown in the embodiment in FIG. 1, in various other embodiments there may be more or less than two recording devices. The recording devices 102a and 102b are generally configured to capture video and/or audio in the learning environment 101 and to provide video and/or audio files to the remote server 110 via the network 130. In some embodiments, the router 105 is a wireless and/or wired router and the recording devices 102a and 102b send data through the router 105 to the network 130. In various embodiments, the recording devices 102a and 102b include one or more cameras and/or microphones positioned in the learning environment 101 to capture any type of event or motion or sound. In some embodiments, each recording device 102a and 102b is a custom built device including, for example, three cameras and microphones configured to capture video and audio from a portion of the learning environment 101. The recording devices 102a and 102b may be located at any position in the learning environment 101, such as in a corner of a classroom, in the center of the classroom, or in any position configured to best capture motion or events in the classroom. An example configuration of the recording device 102a, which can be a same configuration for use as the recording device 102b, is described in greater detail below with reference to FIG. 2.

Referring again to FIG. 1, in various embodiments the remote server 110 is a regional video distribution server (RVDS) that is configured to manage the activity of the recording devices 102a and 102b. In various embodiments, the remote server 110 downloads video and/or audio data, such as files, captured by the recording devices 102a and 102b and other devices and sensors in the learning environment 101. Further, in some embodiments, the remote server 110 uploads software updates to the recording devices 102a and 102b and monitors the health of the recording devices 102a and 102b over the network 130. In some embodiments, the network 130 includes the Internet and the remote server 110 communicates with the recording devices 102a and 102b via a secure Internet Protocol Security (IPSec) tunnel connecting the remote server 110 and the recording devices 102a and 102b.

In various embodiments, the remote server 110 provides storage, such as the database 114 that includes a memory for storing data, such as files, provided by the recording devices 102a and 102b. In some embodiments, the remote server 110 is configured to store several weeks of video files from the recording devices 102a and 102b of the learning environment 101 in the database 114, and to also store video files from recording devices in a plurality of other learning environments in the database 114. Thus, in various embodiments, more than one learning environment can be serviced by the remote server 110. In various embodiments, the remote server 110 is configured to receive data, such as a plurality of files, from recording devices in learning environments that are within a geographic region, such as a city, and is configured to store the data for each of the learning environments in the database 114. This allows the remote server 110 to be associated with a plurality of learning environments in different locations. In various other embodiments, the remote server 110 is dedicated to a single learning environment or the remote server 110 may serve a wider range of learning environments. The remote server 110 may either be local to the learning environment 101 or located remotely from the learning environment 101. In the embodiment of FIG. 1, the remote server 110 is illustrated supporting a single learning environment 101 for the purposes of simplicity only, but the remote server 110 may further be configured to manage the activity in other learning environments.

In various embodiments, the processing circuit 112 of the remote server 110 is configured to process audio and video files. In various embodiments, the remote server 110 processes the files to build a database of inferences relating to the files, to improve the quality of the files, and/or to change a format of the audio and video files. As an example, in some embodiments, the processing circuit 112 is configured to perform facial recognition or voice recognition on a video or audio file to build a database of inferences relating to student attendance, behavior, and/or activity in the learning environment 101. As another example, in some embodiments, the processing circuit 112 is configured to perform low pass filtering, combine multiple audio or video files into a single file, enhance a portion of a video or audio file to highlight a particular behavior or event, and/or to provide other such functionality to process the files for analysis and/or display.

In various embodiments, the audio and video files, and other files and data from remote server 110, are accessible by a one or more applications running on the user devices 120a and 120b over the network 130. The user devices 120a and 120b may each be, for example, a computer, a tablet, a smart phone, or the like. In some embodiments, any number of user devices, such as the user devices 120a and 120b, are able to access the remote server 110 over the network 130. In some embodiments, applications on the user devices 120a and 120b are, for example, Internet-based web applications running on a computer, tablet, mobile phone, or any other type of electronic device. Users may receive information from the remote server 110, may request information from the remote server 110, or may provide information to the remote server 110 via applications on the user devices 120a and 120b.

As an example, in some embodiments a teacher may access an application on the user device 120a to submit notes for a lecture to the remote server 110, and the submission triggers a request to remote server 110 relating to the notes. In some such embodiments, the remote server 110 is configured to determine a video file, audio file, or other data relating to the contents of the notes, and is configured to provide the data to the teacher via the application on the user device 120a, and/or to associate the notes with the data stored in the remote server 110. As another example, in some embodiments, a parent may request to view how his or her child is doing in class using the user device 120b. In some such embodiments, the remote server 110 is configured to retrieve one or more audio or video files related to the child, along with inferred behavioral information about the child, and provide the information and files to the parent via one or more applications on the user device 120b. Some applications on the user devices 120a and 120b are configured to output audio and video files retrieved from the remote server 110 and to display any report or other information from the remote server 110.

In various embodiments, a user of the user device 120a is taken to a home page on an application that allows the user to select a learning environment, such as a particular classroom, and a particular day and/or time. The user may further provide credentials, such as a login and password, to access such information. The user may then scroll through a plurality of videos provided from the remote server 110 that match the selection, such as the user being presented with a plurality of thumbnails of videos that match the selection. Further, in some embodiments, the user device 120a displays an alert from the remote server 110 that alerts the user to video files and other information relating to any special events in the selected classroom.

In various embodiments, the remote server 110 is configured to distribute the files to authorized and authenticated users and user devices, such as the user devices 120a and 120b, through a monitored and policy controlled access control list. For example, the access control list may include a list of approved teachers, students, supervisors, parents, and/or other users. In some such embodiments, the remote server 110 is configured to be authorized to provide files to such persons that are on the list upon receiving login information or other credentials from them at the remote server 110. In some embodiments, the access control list includes a list of approved electronic devices, such as a computer, a tablet, or the like, for accessing the files stored at remote server 110. Also, in some embodiments, different files stored by the remote server 110 are allowed to have different authentication levels, such as an authentication level for parents to have access to files relating to their children, an authentication level for school supervisors to have access to all files, or the like.

In various embodiments, each of the recording devices 102a and 102b are configured to buffer captured video files and/or other files until the files are downloaded by the remote server 110, at which point the files may either be removed from a memory of the corresponding recording device 102a or 102b or temporarily stored. In some embodiments, files may be removed from the recording device 102a when the memory of the recording device 102a becomes full, in which case the oldest stored files may be removed first. Similarly, files may be removed from the recording device 102b when the memory of the recording device 102b becomes full, in which case the oldest stored files may be removed first.

In various embodiments, the recording devices 102a and 102b are configured to record video and audio based on a schedule. For example, in some embodiments, the recording devices 102a and 102b are configured to record a new video in the learning environment 101 every minute. In some such embodiments, the recording devices 102a and 102b are configured to create a new video file lasting one minute for every minute, and may provide the video file a unique name or unique metadata to identify the video file compared to other video files. In some other embodiments, the recording devices 102a and 102b are configured to capture video and audio files for any other time frame, such as every 2 minutes, every 30 seconds, or the like. The present disclosure describes video and audio files for a one minute time frame as an example.

In various embodiments, the recording devices 102a and 102b each include a processing circuit that is configured to perform various processing functions. For example, in various embodiments, the recording devices 102a and 102b are each configured to identify video files that contain movement, and to put such video files in a video motion list. In some instances, the remote server 110 is configured such that if the remote server 110 is unable to download all of the video files captured by the recording devices 102a and 102b due to bandwidth and/or time limitations, then the remote server 110 uses the video motion lists from the recording devices 102a and 102b, as well as timestamps of the video files and/or inputs from other sensors, to download the most relevant video files first, such as, for example, video files with videos that contain a significant amount of activity. In other words, one or more prioritized lists of video files that should be downloaded first by the remote server 110 are created by the recording devices 102a and 102b based on the content of the video files and/or when the video files were captured. The processing of the video files by the recording devices 102a and 102b to generate the lists may be run asynchronously from the process of capturing the video files. For example, the recording device 102a may analyze each video file captured by the recording device 102a for movement, independent of the activity of recording new one-minute long video files.

In various embodiments, the remote server 110 is configured to download the video motion lists from each of the recording devices 102a and 102b and provide the lists to one or more users via applications on the user devices 120a and 120b. In some embodiments, the remote server 110 is configured to allow a user to request any video file from the video motion lists for viewing on a user device, such as the user devices 120a and 120b. In some such embodiments, the remote server 110 is configured to provide the selected video file to the user device for display, and is configured to download the video file from the recording device on which the video file is located, such as the recording device 102a or the recording device 102b, if the video file has not yet been downloaded by the remote server 110, so that the video file can then be provided to the user device, such as the user device 120a or the user device 120b.

In various embodiments, the system 100 supports the use of a video motion list to selectively download video files to the remote server 110. For example, assume that there are ten hours of classwork in the learning environment 101 in a typical day that is captured by the recording device 102a and the recording device 102b. The other fourteen hours may be used by the recording device 102a and the recording device 102b to each create a corresponding video motion list for the videos that they have captured, and to download the most relevant video files as determined from the video motion lists to the remote server 110 over the network 130, and to have the remote server 110 analyze the downloaded video files.

For example, in various embodiments, the recording devices 102a and 102b are configured such that after the classwork is over for the day they each generate a video motion list, which may take, for example, a couple of hours. In some such embodiments, the video motion lists are downloaded from the recording devices 102a and 102b to the remote server 110, and the processing circuit 112 of the remote server 110 is configured to run an algorithm to prioritize files in the video motion lists for download based on a type of movement detected in the video files (or other content of the video) and/or on information provided by users. Also, in some such embodiments, the remote server 110 is configured to download the video files in the prioritized order. This may allow for optimizing the bandwidth of the network 130.

In some embodiments, the use of a prioritized list for downloading video files allows for fewer files, such as only a certain number of the prioritized files, to be downloaded to the remote server 110 than a case in which all video files are downloaded. For example, referring to the above example where a teacher provides notes to the remote server 110, in some embodiments the processing circuit 112 of the remote server 110 is configured to use the notes to determine video files that are related to the notes and to prioritize such video files for download. As another example, a user may provide information to the remote server 110 relating to a specific event of an interaction between two students. In various embodiments, the remote server 110 is configured to receive the information, use the video motion lists to identify videos in which both students are present, and prioritize such video files over other video files in the video motion lists for download by the remote server 110. In various embodiments, the recording devices 102a and 102b are configured to provide information in the video motion lists about students appearing in the videos of the video files by performing facial recognition to identify students in each video file and then annotating the corresponding video motion list with the identified student information. In some embodiments, any combination of information relating to the video motion lists and user-generated information may be used to determine which files are downloaded to the remote server 110 from the recording devices 102a and 102b over the network 130 and in what order.

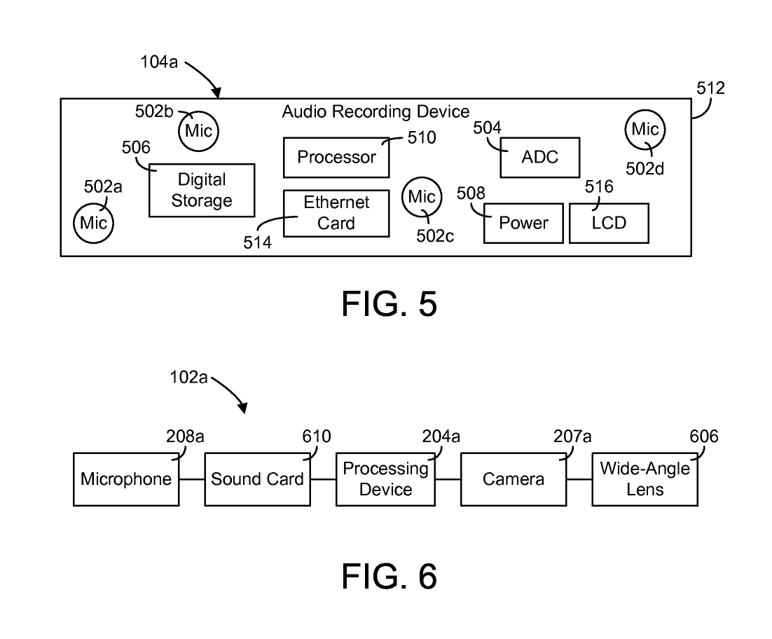

In various embodiments, the learning environment 101 further includes the audio recording devices 104a and 104b. Two audio recording devices 104a and 104b are shown in the embodiment in FIG. 1, but various other embodiments have less than two or more than two audio recording devices. In various embodiments, each of the audio recording devices 104a and 104b includes an array of digital recorders. Also, in various embodiments, the audio recording devices 104a and 104b are placed throughout the learning environment 101 such that they are able to capture sound in the learning environment 101. For example, audio recording devices, such as the audio recording devices 104a and 104b, may be placed at each desk in a classroom, may be placed in equidistant locations around walls of a classroom, or in other locations. In some embodiments, the learning environment 101 may include any number of audio recording devices, such as hundreds placed efficiently to best record sound. In various embodiments, each of the audio recording devices 104a and 104b is configured to record audio files and to store the audio files for download by the remote server 110. In some embodiments, the audio recording devices 104a and 104b are configured to record audio files of a particular time length, such as one minute audio files, and to analyze each audio file for sound. Also, in some embodiments, the audio recording devices 104a and 104b each create an audio list that prioritizes audio files for the remote server 110 to download. In some embodiments, the audio recording devices 104a and 104b communicate with the remote server 110 over the network 130 through the router 105. An example configuration of the audio recording device 104a, which could also be a configuration used for the audio recording device 104b, is described in greater detail below with respect to FIG. 5.

Referring again to FIG. 1, in various embodiments the remote server 110 is configured to combine together audio files from the audio recording devices 104a and 104b. Combining the audio files together for the same period of time may result in a clearer audio signal. In some embodiments, the remote server 110 is configured to use the audio files to follow or track a location or movement of a person or event in the learning environment 101. For example, a person speaking and moving in the learning environment 101 may be tracked using audio files from the audio recording devices 104a and 104b. In some embodiments, the remote server 110 is further configured to use video files from the recording devices 102a and 102b along with audio files from the audio recording devices 104a and 104b to follow or track a location or movement of a person or event in the learning environment 101. In some embodiments, the remote server 110 is configured to use audio files from the audio recording devices 104a and 104b to perform triangulations to locate the source of a sound. Also, in some embodiments, the remote server 110 is configured to combine audio files into a single file to have a continuous recording of an event that happened in the learning environment 101. Combining audio files from the audio recording devices 104a and 104b also allows the remote server 110 to properly capture events in the learning environment 101, even if students and teachers are moving around in the classroom.

In various embodiments, some of the audio recording devices, such as the audio recording devices 104a and 104b are wearable and Bluetooth enabled. In some embodiments, the audio recording devices, such as the audio recording devices 104a and 104b are snapped to or mounted on a wall, desk, student, or any object or person and provide an audio input for download by the remote server 110. For example, an audio recording device, such as the audio recording device 104a or the audio recording device 104b, may be designated for a particular desk or student, and may include an identifier to associate it with a desk or student. In various embodiments, the audio recording devices 104a and 104b further include user interfaces, such as buttons, switches, touch screens, or the like to allow a user to communicate information to the remote server 110, or to receive an indication from the remote server 110. In various embodiments, the remote server 110 functions with the audio recording devices 104a and 104b in a similar manner to the recording devices 102a and 102b as described above. For example, audio files may be prioritized by a processing circuit of an audio recording device, such as the audio recording device 104a or the audio recording device 104b, or by the remote server 110 for download by the remote server 110 by a similar process as described above with reference to video files.

In various embodiments, data transmitted over the network 130 is secured over the network using encryption. In some embodiments, the system 100 is secured such that only authorized users may access resources on the recording devices 102a and 102b and on the remote server 110 through applications on the user devices 120a and 120b. In some embodiments, the remote server 110 is configured to maintain an access control list as described above to control access to various devices in the system 100 and to audit usage of various devices in the system 100 by various users, so as to confirm compliance of the users with the formal data access policies of the system 100. The access control list may include, for example, teachers, students, parents, administrators, other educators, or the like to support any user involved in the educational process.

In various embodiments, the system 100 includes one or more environment sensors, such as the environment sensor 106 in the learning environment 101. The environment sensor 106 is configured to provide additional information about the learning environment 101 to the remote server 110 over the network 130. In some embodiments, the environment sensor 106 communicates through the router 105 over the network 130 with the remote server 110. The environment sensor 106 can be any type of sensor and may be, for example, a temperature sensor, a light sensor, a humidity sensor, an air quality sensor, a motion sensor, or the like. In some embodiments, the environment sensor 106 is a temperature sensor and provides a temperature level reading periodically to the remote server 110 over the network 130.

The network 130 may be any type of network or combination of different types of networks, such as the Internet, a local area network (LAN), a wide area network (WAN), or the like. The various devices in the system 100 may connect to the network 130 via any type of network connection, such as a wired connection such as Ethernet, a phone line, a power line, or the like, or a wireless connection such as Wi-Fi, WiMAC, 3G, 4G, satellite, or the like.

FIG. 2 illustrates an example configuration of the recording device 102a in accordance with an embodiment that is connected to the network 130 and a power supply 220. In various embodiments, the recording device 102a includes a housing 202, a processing device 204a, a processing device 204b, a processing device 204c, a wireless transceiver 209, an Ethernet switch 210, an RJ45 connector 212, a power supply (VAC) connector 222, an alternating current to direct current (AC/DC) inverter 224, a USB hub 230, a USB connector 232, and a storage device 240. In various embodiments, the recording device 102a further includes a camera 207a and a microphone 208a connected to the processing device 204a and mounted on a mount 206a, a camera 207b and a microphone 208b connected to the processing device 204b and mounted on a mount 206b, and a camera 207c and a microphone 208c connected to the processing device 204c and mounted on a mount 206c.

With reference to FIGS. 1 and 2, the recording device 102a is configured to capture audio and video files for a portion or all of the learning environment 101, and to provide the files for download to the remote server 110. In various embodiments, the recording device 102a is configured to provide a panoramic view of the learning environment 101 from a centered high permanent wall mounted location, allowing the recording device 102a to capture up to 180 degrees of area, minimize a number of discrete perspectives, and minimize audio and video distortion. In some embodiments, the cameras 207a, 207b, and 207c are positionable to capture video for at least 174 degrees of area in the learning environment 101. In other embodiments, the recording device 102a may be located in any other position in the learning environment 101, may be mounted to any surface, and may or may not be permanently installed.

In various embodiments, the recording device 102a includes the housing 202 for housing the processing device 204a, the processing device 204b, the processing device 204c, the Ethernet switch 210, the AC/DC inverter 224, the USB hub 230, and the storage device 240. In some embodiments, the camera 207a, the microphone 208a, the camera 207b, the microphone 208b, the camera 207c, and the microphone 208c are partially or entirely housed within the housing 202. The illustrated embodiment of the recording device 102a shows three cameras 207a, 207b, and 207c and three microphones 208a, 208b, and 208c, each connected a corresponding one of three processing devices 204a, 204b, and 204c, but various other embodiments can have more or less than three cameras and/or microphones and more or less than three processing devices, and in some embodiments all cameras and microphones in a recording device may be connected to a single processing device. In various embodiments the recording device 102b has a same configuration as the recording device 102a.

In various embodiments, each camera 207a, 207b, and 207c is configured to capture video data and to provide the video data to a corresponding one of the processing devices 204a, 204b, and 204c. Also, in various embodiments, each microphone 208a, 208b, and 208c is configured to capture audio data and to provide the audio data to a corresponding one of the processing devices 204a, 204b, and 204c. In some embodiments, each camera 207a, 207b, and 207c, and each microphone 208a, 208b, and 208c is attached to a corresponding one of the mounts 206a, 206b, and 206c, which may be a locking mount, a rotatable mount, a swivel mount, or the like, and may be positioned such that the cameras 207a, 207b, and 207c, and the microphones 208a, 208b, and 208c extend from the housing 202 to capture video and audio in the learning environment 101. In various embodiments, the mounts 206a, 206b, and 206c are positioned in the recording device 102a to allow for the cameras 207a, 207b, and 207c to have a panoramic view of the learning environment 101. The mounts 206a, 206b, and 206c may be adjustable in position, such as by a user, or automatically or controllably by the recording device 102a.

Each processing device 204a, 204b, and 204c is configured to process the video and audio data received from the corresponding camera 207a, 207b, and 207c and the corresponding microphone 208a, 208b, 208c. In some embodiments, each processing device 204a, 204b, and 204c is a system on a chip (SoC) that includes a processor, a graphics processing unit (GPU), and random access memory (RAM). In some embodiments, each processing device 204a, 204b, and 204c includes a Raspberry Pi™ system on a chip that is programmed to perform processing. In various embodiments, each processing device 204a, 204b, and 204c is configured to provide video files to the storage device 240 based on the video and audio data and to process each video file to detect whether there is motion in the video of the video file in order to generate a video motion list specifying video files that have motion in the video. In some embodiments, each processing device 204a, 204b, and 204c combines the video data and audio data into combined video files and is configured to process each video file to detect whether there is audible sound in the video file in order to generate an audio list specifying files that have audible sound. In various embodiments, each processing device 204a, 204b, and 204c is configured to store and retrieve video files and lists to and from the storage device 240 and to provide the video files and lists, such as video motion lists or audio lists, to the Ethernet switch 210 for transmission through the RJ45 Connector 212 to the network 130.

In some embodiments, each processing device 204a, 204b, and 204c is configured to respond to requests for video files from the remote server 110 to provide specifically requested video files to the remote server 110 over the network 130. In some embodiments, each processing device 204a, 204b, and 204c is further configured to process video files for facial recognition and to tag the video files with information about date, time, location, and people appearing in the video files, and to provide the information to the remote server 110 over the network 130.

FIG. 6 illustrates a portion of the recording device 102a in accordance with an embodiment including the processing device 204a, the camera 207a, the microphone 208a, a wide-angle lens 606, and a sound card 610. With reference to FIGS. 1, 2, and 6, in various embodiments, the camera 207a and the microphone 208a are configured to capture video and audio, respectively, in the learning environment 101. In some embodiments, the microphone 208a is integrated into the camera 207a and the camera 207a provides both video and audio data. In various embodiments, the processing device 204a includes a single-board computer (SBC) configured to facilitate processing of the video and audio in the learning environment 101.

In various embodiments, the camera 207a includes an image sensor that is configured to capture images for video. In some embodiments, the camera 207a is, for example, a 5 Megapixel (MP) Raspberry Pi™ camera module, coupled to the processing device 204a. The wide-angle lens 606 may be a fixed focus lens coupled to the camera 207a. In various embodiments, the microphone 208a is, for example, an electret microphone that is configured to capture audio. In some embodiments, the microphone 208a is connected to the sound card 610, such as, for example, a USB sound card, that receives data from the microphone 208a and provides processed audio data to the processing device 204a.

In various embodiments, the recording device 102a includes the Ethernet switch 210 and the RJ45 connector 212 for connecting the processing devices 204a, 204b, and 204c, the cameras 207a, 207b, and 207c, the microphones 208a, 208b, and 208c, the wireless transceiver 209, and the storage device 240 to the network 130. This may allow the remote server 110 to provide updates to the various components of the recording device 102a and to download data obtained by the cameras 207a, 207b, and 207c, the microphones 208a, 208b, and 208c, and the wireless transceiver 209. In various embodiments, the recording device 102a includes the VAC connector 222 connected to the power supply 220 and to the AC/DC inverter 224 for providing power from the power supply 220 to the various components of the recording device 102a. The power supply 220 may be any type of power supply, such as a battery, an alternating current (AC) power supply using a plug, or the like. In some embodiments, the recording device 102a includes the USB hub 230 and the USB connector 232 for connecting to external devices. In some embodiments, a user may download files from the recording device 102a via the USB connector 232.

In various embodiments, the recording device 102a includes the storage device 240. In some embodiments, the storage device 240 is configured to store video and audio files for a given period of time, such as files recorded in the last day, video files from the past several days, or the like. In various embodiments, the storage device 240 further stores a video motion list and\or other similar lists which indicate a priority of the various files stored. In various embodiments, each processing device 204a, 204b, and 204c (or a general processing circuit of the recording device 102a) is configured to process audio and video files and to determine if each file processed should be placed in a video motion list (or other similar list), the position of the file in the list, and other priority information for the file. Storage device 240 may be configured to store one or more video motion lists along with the video files, for retrieval by the remote server 110 via the network 130.

Various features may be provided to a user via applications running on the user devices 120a and 120b that interact with the recording device 102a. For example, in some embodiments a user interface is provided that allows a user to select a particular view, such as a particular camera 207a, 207b, 207c of the recording device 102a. In some embodiments, the user may further adjust a position of one or more of the cameras 207a, 207b, and 207c remotely using an interface of provided on one or more of the user devices 120a and 120b.

Referring to FIGS. 1 and 2, in various embodiments each of the wearable devices 107a and 107b are worn by a corresponding student in the learning environment 101 and are configured to provide a wireless signal that is receivable by the wireless transceiver 209 of the recording device 102a. In some embodiments, the wireless transceiver is a radio frequency (RF) transceiver such as, for example, an IQRF™ transceiver. In some embodiments, the wireless transceiver 209 is connected to provide data to each of the processing devices 204a, 204b, and 204c. In various embodiments, the recording device 102b also includes a wireless transceiver just like the wireless transceiver 209 of the recording device 102a.

In some such embodiments, the recording devices 102a and 102b are configured to communicate with each other, such as through the router 105, to determine which of the recording devices 102a and 102b is the closest to a student wearing a wearable device, such as the wearable device 107a, at any given time based on a signal provided from the wearable device 107a and received by the wireless transceiver 209 of each of the recording devices 102a and 102b. In some embodiments, the recording devices 102a and 102b are configured to use a signal strength of the signal provided from the wearable device 107a and received by the wireless transceiver 209 of each of the recording devices 102a and 102b to determine which of the recording devices 102a and 102b the wearable device 107a is closer to at a particular time. In some embodiments, the recording devices 102a and 102b provide such information about the locations of the wearable devices 107a and 107b to the remote server 110. Also, in some embodiments, the user devices 120a and 120b provide applications that allow a user to specify a name of a student and a time of day to the remote server 110 to request a video file, and then the remote server 110 is configured to determine a video file that most likely included the student at that time based on the information about the locations of the wearable devices provided from the recording devices 102a and 102b, and to provide the video file to the requesting user device.

In various embodiments, the recording devices 102a and 102b are configured for digital audio and video recording, transcoding, and processing. In some embodiments, the video has, for example, 1080p resolution at 24 frames per second, and the audio has, for example, 44.1 ksps CD quality. In some embodiments, the recording devices 102a and 102b are configured to scan audio and video content of files to label the audio and video files based on the content for later use. In some embodiments, the recording devices 102a and 102b are controllable through a user interface, such as a Web browser based HTML5 and Javascript interface, that provides the ability to choose cameras of the recording devices 102a and 102b using an overview dashboard, allows for streaming or pseudostreaming of video from the recording devices 102a and 102b, allows a user to review any perspective in the learning environment 101 at any time the recording devices 102a and 102b are activated, and that provides for administration of the recording devices 102a and 102b. In some embodiments, administration of the recording devices 102a and 102b is performed using command line tools, scripts, and/or revision control.

In some embodiments, the recording devices 102a and 102b provide video and/or audio data in MP4 format. In some embodiments, video recording streams use, for example, an MP4 container with H.264 video at 600W×800H recording at 24 fps and WAV 44.1 CD quality audio recording. In some embodiments, a thumbnail size format uses, for example, an MP4 container with H.264 video at 120W×160H recording at 24 fps. In some embodiments, the video and/or audio data is segmented, for example, by providing 2 minute long MP4 segments. In some embodiments, video and audio data are packaged in a format such as ffmpeg. In some embodiments, the recording devices 102a and 102b are configured to name each file using a world wide web filename format that includes a name of the learning environment, a timestamp of when the data in the file was captured, an indication of whether the video in the file is full size or a thumbnail, and a media access control address (MAC) associated with a processing device in the recording device. In some embodiments, post-processing can be done on the video files using the computing and storage system 140, which may be a cloud computing system, for example, to align videos.

In some embodiments, the user devices 120a and 120b include a user interface for accessing the video files. In various embodiments, the user interface includes a landing page that asks what learning environment to look at and a precise date and time the user wants to see, and then the user can see thumbnails of each of the recording devices in that learning environment and can choose one of the thumbnail videos to see and hear it in a full version. In some embodiments, an application programming interface (API) includes HTTP requests for accessing the video files and/or other information, and the user devices 120a and 120b can issue the HTTP requests to the remote server 110 to access the video files and/or other information. For example, an HTTP request including the command GET /v1/classroom could return a list of classrooms, an HTTP request including the command GET /v1/classroom/:classroomid could return lists of videos from each camera for the classroom specified by the classroomid, an HTTP request including the command GET /v1/classroom/:classroomid/:cameraid could list videos from a classroom camera specified by the cameraid, and an HTTP request including the command GET /v1/classroom/:classroomid/:cameraid/:videoid could return streaming video for the video specified by the videoid.

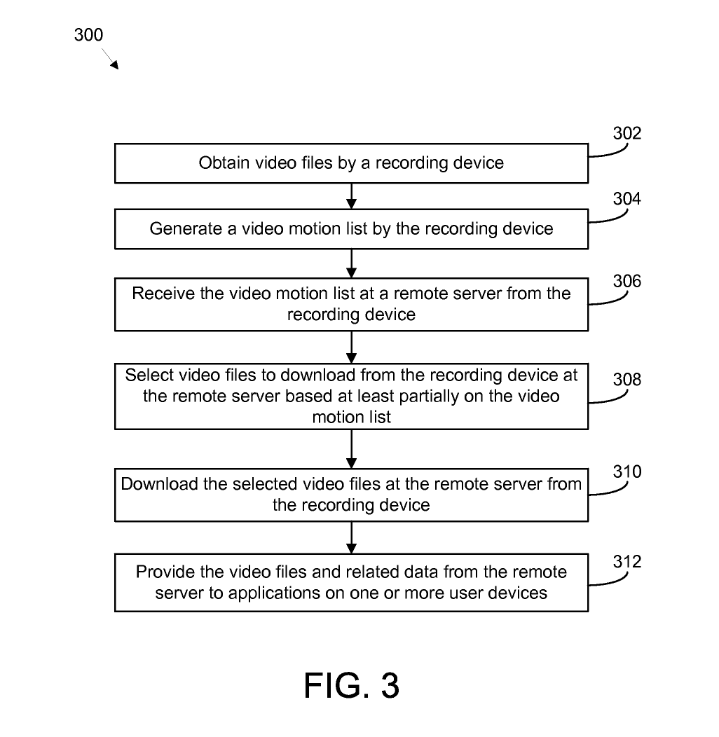

FIG. 3 illustrates a flowchart of a method or process 300 of prioritizing video files for download, according to an exemplary embodiment. With reference to FIGS. 1, 2, and 3, the process 300 may be executed by the system 100, and more particularly by the processing device 204a of the recording device 102a and remote server 110. In various embodiments, a same process is performed by other processing devices in recording devices in communication with the remote server 110. The process 300 may be executed to prioritize video files to be downloaded to the remote server 110 over the network 130 in an efficient manner.

In step 302, video files are obtained throughout a day by the recording device 102a, such as by the processing device 204a receiving video and audio data from the camera 207a and the microphone 208a to create the video files. In some embodiments, a new video file may be created, for example, every minute. Also, in some embodiments, video files are captured throughout a complete day of activity in the learning environment 101, such as, for example, 10 hours. In step 304, the recording device 102a generates a video motion list. In various embodiments, the video motion list is a list of video files in which motion (or another event) is detected. In some embodiments, a threshold for determining if motion (or another event) occurred may vary based on a detected person and activity, such as a student moving around a classroom being deemed as significant motion, a teacher walking around a classroom being deemed as significant motion, a student leaning over during a test being deemed as significant motion, or the like, and may be based on any parameter determined by the processing device 204a or specified by a user. In various embodiments, the processing device 204a is configured to process the video files to determine if there is motion in the video and to determine based on the motion determination whether the add the video file to the video motion list. In various embodiments, the video motion list provides file names of the video files in a ranked order of importance for download.

In step 306, the video motion list is transmitted from the recording device 102a and received by the remote server 110. In step 308, the remote server 110 selects which video files to download from the recording device 102a based at least partially on the video motion list. In some embodiments, the remote server 110 may include its own criteria for determining which video files are most relevant to the server based on the video motion list and other information relating to the video files provided by the recording device 102a or other devices, such as information from the environment sensor 106 placed in the learning environment, or from information provided by users from the user devices 120a and 120b. Alternatively, in some embodiments, step 308 may be executed at least in part by the processing device 204a of recording devices 102a.

In step 310, the remote server 110 downloads the prioritized selected video files from the recording device 102a. In step 312, the remote server 110 provides the video files and/or other related data to users via applications on the user devices 120a and 120b. In some embodiments, the video files may be downloaded from the recording devices 102a to the remote server 110 at night or at any other time during which the recording activities in learning environment 101 are inactive, so that the transfer of data does not tie up the network 130 during class time.

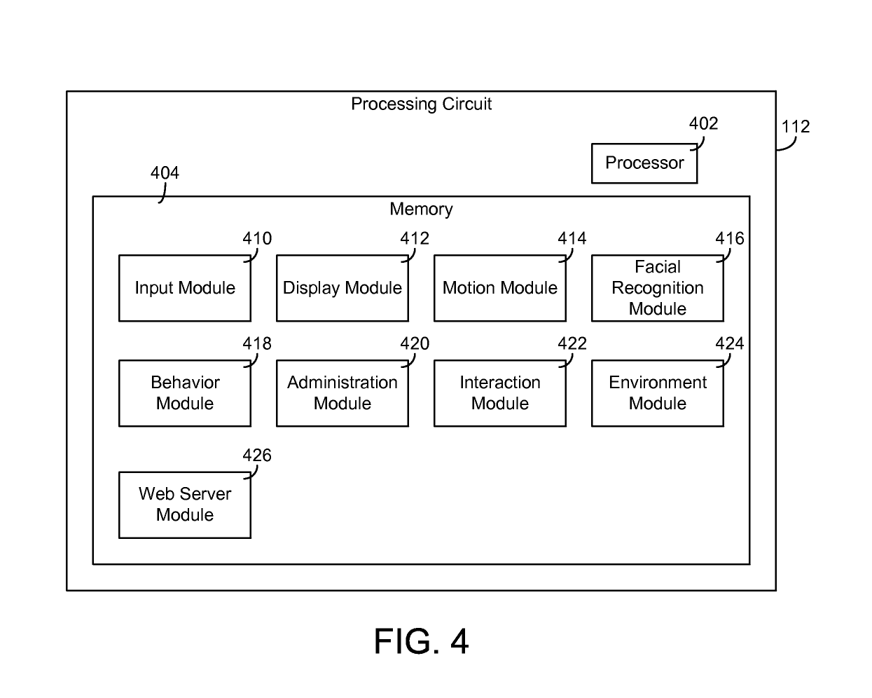

FIG. 4 illustrates a block diagram of the processing circuit 112 of the remote server 110 of FIG. 1 in accordance with an embodiment. In various embodiments, the processing circuit 112 includes a processor 402 and a memory 404. In various embodiments, the processor 402 may be implemented as a general purpose processor, an application specific integrated circuit (ASIC), one or more field programmable gate arrays (FPGAs), a group of processing components, or other suitable electronic processing components. In various embodiments, the memory 404 is one or more devices, such as RAM, ROM, flash memory, hard disk storage, flash memory storage, or the like, for storing data and/or computer code for completing and/or facilitating the various user or client processes, layers, and modules described in the present disclosure. In some embodiments the memory 404 may include database components, object code components, script components, or any other type of information structures for supporting the various activities and information structures of the present disclosure. In various embodiments, the memory 404 is communicably connected to the processor 402 and includes computer code or instruction modules for executing one or more processes described herein.

The memory 404 in accordance with an embodiment is shown to include various modules for completing the activities described herein. The memory 404 may include an input module 410 that is configured to manage input received from users via applications. For example, the input module 410 may control the processing circuit 112 to receive input and determine a user request based on the input, such as to retrieve a particular video file, to provide a particular command to a recording device, or the like, and to provide a user request to an appropriate module. The memory 404 may include a display module 412 that is configured to cause the processor 402 to format a video file, an audio file, or other information for output to a user device. For example, the display module 412 may cause the processor 402 to format a video file for playback on a computer, may generate a report providing detailed behavior information, or the like.

In various embodiments, the memory 404 includes a motion module 414 that is configured to cause the processor 402 to detect motion in a video file, and to characterize the motion, such as to differentiate between suspicious motion and non-suspicious motion. In some embodiments, the memory 404 includes a facial recognition module 416 that is configured to cause the processor 402 to perform facial recognition for a video in order to identify people in the video. In some embodiments, the motion module 414 and the facial recognition module 416 when executed by the processor 402 work in conjunction to identify the movement of a particular person in a video. In various embodiments, the facial recognition module 416 may further cause the processor 402 to detect a mood of a person in a video based on facial expressions of the person.

In various embodiments, the memory 404 includes a behavior module 418 that is configured to cause the processor 402 to detect and document student behavior in videos. For example, the behavior module 418 may be used to cause the processor 402 to track how often a problem behavior occurs, to track student behavior, or the like. In various embodiments, the memory 404 includes an administration module 420 that is configured to cause the processor 402 to provide information relating to a learning environment, such as allowing janitors and other personnel to access the learning system to determine if a classroom needs special attention or maintenance.

In various embodiments, the memory 404 includes an interaction module 422 that is configured to cause the processor 402 to detect interactions between two or more people in a video. For example, the interaction module 422 when executed by the processor 402 may review interactions during a group project in a classroom, may detect when unwanted interactions are occurring, or the like. As an example, in some embodiments, if a teacher is doing a one-on-one session, the interaction module 422 may cause the processor 402 to monitor the activity of the rest of the classroom for the teacher.

In various embodiments, the memory 404 includes an environment module 424 that is configured to cause the processor 402 to track various environmental factors in a learning environment. For example, lighting levels and temperature may be checked in the learning environment. In some embodiments, the memory 404 includes a web server module 426 to cause the processor 402 to perform as a web server to serve files or other information to requesting devices. The various modules illustrated in FIG. 4 are provided by way of example only, and it should be understood that various other modules providing functionality related to the systems and methods described herein may be included in the processing circuit 112.

As described above with reference to FIG. 1, in various embodiments the learning environment 101 includes the audio recording devices 104a and 104b. In various embodiments, each of the audio recording devices 104a and 104b include an array of audio digital recorders, and the audio recording devices 104a and 104b can be placed at various locations in the learning environment 101. In some embodiments, the audio recording devices 104a and 104b are each configured to record sound and store audio files for download by the remote server 110.

FIG. 5 illustrates an example configuration of the audio recording device 104a in accordance with an embodiment. With reference to FIGS. 1 and 5, in various embodiments, the learning environment 101 includes a plurality of audio recording devices, such as audio recording devices 104a and 104b, that are placed in any type of arrangement throughout the area of the learning environment, such as at each desk or seat in a classroom, equidistant from each other, on walls, or the like. In various embodiments, each of the audio recording devices, such as the audio recording devices 104a and 104b has a configuration as shown in the embodiment for the audio recording device 104a in FIG. 5. With reference to FIGS. 1 and 5, in various embodiments the audio recording device 104a is configured to record, store, and upload audio data to the remote server 110 to allow for observation and analysis of events in the learning environment 101.

In various embodiments, the audio recording device 104a includes an array of audio sensors, such as an array of electret microphones 502a, 502b, 502c, and 502d that are plugged into a printed circuit board 512 of the audio recording device 104a. While four microphones 502a, 502b, 502c, and 502d are shown in the embodiment of the audio recording device 500, in various other embodiments any number of microphones may be included in the audio recording device 104a. Further, the locations of the microphones 502a, 502b, 502c, and 502d on the printed circuit board 512 of the audio recording device 104a may vary and may be configured in a way to best capture audio.

In various embodiments, the audio recording device 104a further includes an analog-to-digital converter (ADC) 504, a digital storage 506 (or other storage), a power module 508, an Ethernet card 514, and a liquid crystal display (LCD) 516. The ADC 504 may be any type of analog-to-digital converter that is configured to convert audio captured by the microphones 502a, 502b, 502c, and 502d into a digital format for processing by a processor 510 of the audio recording device 104a. In some embodiments, there is a separate analog-to-digital converter for each of the microphones 502a, 502b, 502c, and 502d. The digital storage 506 is configured to store digital audio files for transmission to the remote server 110. The power module 508 provides power to the components of the audio recording device 104a and may allow, for example, the audio recording device 104a to be plugged into a power socket, or for power to be obtained from a battery. In various embodiments, the Ethernet card 514 receives audio files from the processor 510 and transmits the audio files over a network, such as the network 130. In some embodiments, rather than having the power module 508, the Ethernet card 514 includes a Power over Ethernet (PoE) module that is any type of system or module configured to provide a data connection and a power source to the elements of the audio recording device 104a. For example, the PoE module may facilitate communications and connections with other devices, such as the audio recording device 104b, the recording devices 102a and 102b, the network 130, and/or the router 150. Also, power may be supplied over an Ethernet connection to the audio recording device 104a through the PoE module. In some embodiments, the audio recording device 104a includes separate data communication and power ports.

In various embodiments, the processor 510 of the audio recording device 104a is attached to the printed circuit board 512 and is configured to determine which audio files to prioritize for downloading by the remote server 110, similarly as described above with reference to the video files of the recording devices 102a and 102b. In various embodiments, audio files including audio captured by the microphones 502a, 502b, 502c, and 502d are analyzed and prioritized by the processor 510 to generate an audio list to prioritize audio files for download by the remote server 110 base at least partially on the contents of the audio files. In some embodiments, the processor 510 analyzes the audio files to determine whether someone is speaking in a file and prioritizes the audio files with speech for download by the remote server 110. In various embodiments, the processor 510 sends the audio list to the remote server 110. In some embodiments, the audio recording device 104a includes the Ethernet card 514 that is inserted into the printed circuit board 512 to transmit and receive files and information, such as the audio files.

In some embodiments, the various components of the audio recording device 104a are placed in a housing that may be, for example, a 20 cm×4 cm container or a container of any other size, and may be configured to be attached to any object, such as a wall, a ceiling, any fixture in a room, a person, or the like, by any type of fastening method. In some embodiments, the audio recording device 104a is configured to be easily mounted and/or moved in the learning environment 101 and to support a cable connection to provide power and network connectivity to the audio recording device 104a. In some embodiments, the audio recording device 104a is configured to be associated with a particular person or object, such as a particular student, a teacher, a particular desk, a particular region of the learning environment 101, or the like.

In various embodiments, the remote server 110 is configured to merge the audio from a plurality of audio recording devices, such as the audio recording devices 104a and 104b, with the video captured by a plurality of recording devices, such as the recording devices 102a and 102b. In various embodiments, the remote server 110 is configured to improve range and audio quality by using the audio input from the plurality of audio recording devices, such as the audio recording devices 104a and 104b. In other words, since the audio is captured from multiple devices, the remote server 110 may combine the various audio inputs to create a higher quality audio file. For example, a conversation may be occurring between two occupants in different locations in the learning environment 101 and one of the audio recording devices 104a and 104b may be well-positioned to capture audio from one of the occupants but not the other, and vice versa for the other audio recording device, and the remote server 110 may be configured to combine the audio files from the two audio recording devices 104a and 104b to create a single audio file that captures the conversation between the two occupants. Further, if the occupants are moving around in the learning environment 101, the remote server 110 may be configured to combine audio files from several audio recording devices, such as the audio recording devices 104a and 104b, to best capture the conversation.

In some embodiments, the audio collected by the audio recording devices 104a and 104b is used to determine a number of occupants in the learning environment 101, locations of the occupants, and/or other such metrics. For example, in various embodiments, the remote server 110 is configured to receive audio files from a plurality of audio recording devices, such as the audio recording devices 104a and 104b, over the network 130 and to determine a distinct number of voices or sounds and/or a distinct location for each voice or sound and/or to determine a number of occupants based on voices or other sounds in the audio files.

In some embodiments, the remote server 110 is configured to transcribe particular words or phrases from the audio files, and to record the words or phrases along with a timestamp and location for the words or phrases. This allows the remote server 110 to, for example, improve objective assessment, provide a surface to affect re-ranking of suggested curriculum, build a histogram of words or phrases students are using in the classroom, or understand when and how newly introduced concepts are used.

The audio captured by audio recording devices 104a and 104b may further be used for various other application. For example, in some embodiments, the remote server 110 is configured to use the audio recordings to determine high-level metrics for determining emotional states of areas of the learning environment 101. In some embodiments, the remote server 110 is configured to use the audio recordings along with the locations of the audio recording devices, such as the audio recording devices 104a and 104b, capturing the audio to identify speakers in the learning environment 101. In some embodiments, the remote server 110 is configured to derive metrics representing characteristics of a conversation based on content of the audio files. As another example, the audio files may be used in user research, for teacher self-evaluation and continuous education, or to capture interesting classroom moments.

In various embodiments, the audio recording device 104a records all audio clearly in, for example, a 4 m×2 m×2 m space (height×width×depth) using a set of wall mounted audio arrays. Each array in the set of arrays may include, for example, 4 microphones in a strip, such as the microphones 502a, 502b, 502c, and 502d. In various embodiments, the audio recording devices 104a and 104b are arranged in long stripes across a wall of the learning environment 101 as a sensor network at about 1.5 m off of the ground.

In various embodiments, the audio recording devices 104a and 104b including the audio arrays are connected to each other using USB and the USB hub 103, which is also connected to the teacher computing device 109, which may be a workstation, a laptop, a tablet, a smart phone, or the like, that allows for programming the processors, such as the processor 510, of the audio recording devices 104a and 104b and for logging results as well as receiving audio files over a serial connection. In some embodiments, the teacher computing device 109 transfers the audio files from the audio recording devices 104a and 104b to the remote server 110 and/or the computing and storage system 140 for long-term storage, and also provides monitoring and control capability for the audio recording devices 104a and 104b. In some embodiments, there is a workstation separate from the teacher computing device 109 that performs those functions.

In various embodiments, the teacher computing device 109 is configured to synchronize its real-time clock using the network time protocol (NTP), so that it is as precise as possible. Then, in various embodiments, the teacher computing device 109 is configured to use a custom synchronization protocol to align clocks of the processors of the audio recording devices 104a and 104b, such as a clock of the processor 510 that has a crystal on board in various embodiments. Such synchronization provides high precision time keeping and allows audio files to be precisely aligned in time during post-processing. In various embodiments, each audio file generated by the audio recording devices 104a and 104b is tagged with a timestamp by the audio recording devices 104a and 104b to indicate when the audio file was generated.

In various embodiments, the audio recording device 104a generates a waveform audio file format (WAV) file per microphone, such as for each microphone 502a, 502b, 502c, and 502d, for each time period, and stores the audio files in the digital storage 506 as, for example, 100 MB audio clips. In such embodiments, therefore, there are 4 clips generated at the same time to be stored in the digital storage 506 by the processor 510. In various embodiments, the processor 510 is configured to execute software that has, for example, 8 concurrent contexts of execution (cogs) that perform functions such as (1) an interactive cog for interfacing with a workstation or other computer, such as the teacher computing device 109, over a serial connection to provide for text and data transfer and to act as an agent on behalf of the workstation to read debug registers of the audio recording device 104a and the like; (2) an ADC driver cog to read the ADC data streams from the ADC 504 and write to input buffers of a WAV cog; and (3) the WAV cog to process an input ring buffer from the ADC driver cog for the microphones 502a, 502b, 502c, and 502d, and write the resulting WAV files to the digital storage 506.

In various embodiments, the use of 4 microphones 502a, 502b, 502c, and 502d allows for 12-bit digital audio recording at 20 ksps/channel on 4 channels. In some embodiments, the digital storage 506 has, for example a storage capacity for multiple days of streaming audio data. In various embodiments, the processor 510 provides for audio processing and filtering. In some embodiments, the processor 510 is configured to transmit data, for example, at 112 kbps serial over a USB interface. In some embodiments, the processor 510 includes a software interface that allows for customizing an operational workflow, such as recording during the day and uploading the audio files over the network 130 at night. In some embodiments, the LCD 516 includes an LCD alphanumeric display on the printed circuit board 512 with, for example, a one-wire serial interface. In various embodiments, multiple input/output pins of the processor 510 are connected to the Ethernet card 514 for data transfer.

In some embodiments, each of the microphones 502a, 502b, 502c, and 502d along with an amplifier are on a corresponding daughter card with a 3-pin header interface that can plug into the printed circuit board 512. In some embodiments, the Ethernet card 514 and the printed circuit board 512 have independent unregulated direct current (DC) power and do not control the power of each other. In some embodiments, the Ethernet card 514 runs, for example, in a 5 V mode, and there is level conversion circuitry to allow the Ethernet card 514 to talk to the processor 510 that may be running, for example, in a 3.3 V mode. In some embodiments, the Ethernet card 514 supports the transmission of streaming audio from the processor 510. In various embodiments, the processor 510 and the Ethernet card 514 communicate with each other over a bidirectional command and data bus. In various embodiments, the Ethernet card 514 is configured to use the bus to command the processor 510 to perform functions, such as to start audio recording and to download audio and log data from the digital storage 506.

In some embodiments, the processor 510 includes, for example, 32 input/output pins in which 2 pins are used for serial reception and transmission of data, 2 pins are used for connection to an EEPROM, 4 pins are connected to the digital storage 506, 16 pins are connected to four ADC circuits, such as the ADC 504, for each of the microphones 502a, 502b, 502c, and 502d, 7 pins are used for an interface to the Ethernet card 514, and 1 pin is used for a serial interface to the LCD 516 to transmit information for display on the LCD 516. In some embodiments, software executing on the processor 510 includes 8 cogs that are independent processing units used in the following manner: (1) a main cog for initializing the whole audio recording device 104a and maintaining a control flow; (2) a memory cog for outputting data to the digital storage 506 at a full data rate; (3) an Audio #1 cog for sampling audio from the microphone 502a up to, for example, 35 ksps; (4) an Audio #2 cog for sampling audio from the microphone 502b up to, for example, 35 ksps; (5) an Audio #3 cog for sampling audio from the microphone 502c up to, for example, 35 ksps; (6) an Audio #4 cog for sampling audio from the microphone 502d up to, for example, 35 ksps; (7) an audio processing cog that implements various signal processing techniques on the received audio data; and (8) a flexible cog for performing any other needed routines.

In some embodiments, the processor 510 is configured to provide for logging, responding to errors, and monitoring, and is configured to respond to queries from a host device, such as the teacher computing device 109, over USB, a serial connection, Ethernet, or the like. In various embodiments, the host, such as the teacher computing device 109, polls the processor 510 over the USB hub 103 at various time intervals such as, for example, every 10 minutes. In some embodiments, the results of the polling are sent to the database 114 of the remote server 110 using, for example, an Ethernet connection to the router 105 for transmission over the network 130. In some embodiments, the polled information is sent to the computing and storage system 140, which may include, for example, a relational database service (RDS) server using database software in a cloud computing environment. In some embodiments, a global ID is assigned to each of the audio recording devices 104a and 104b, and the global ID is used as a primary key in a database for storing information from the corresponding one of the audio recording devices 104a and 104b. In some embodiments, a timestamp is maintained for each record that is created for every heartbeat for each of the audio recording devices, such as the audio recording devices 104a and 104b, in the global network, where the record includes, for example, a location ID, hardware and software version information, an audio quality metric, and log message strings.

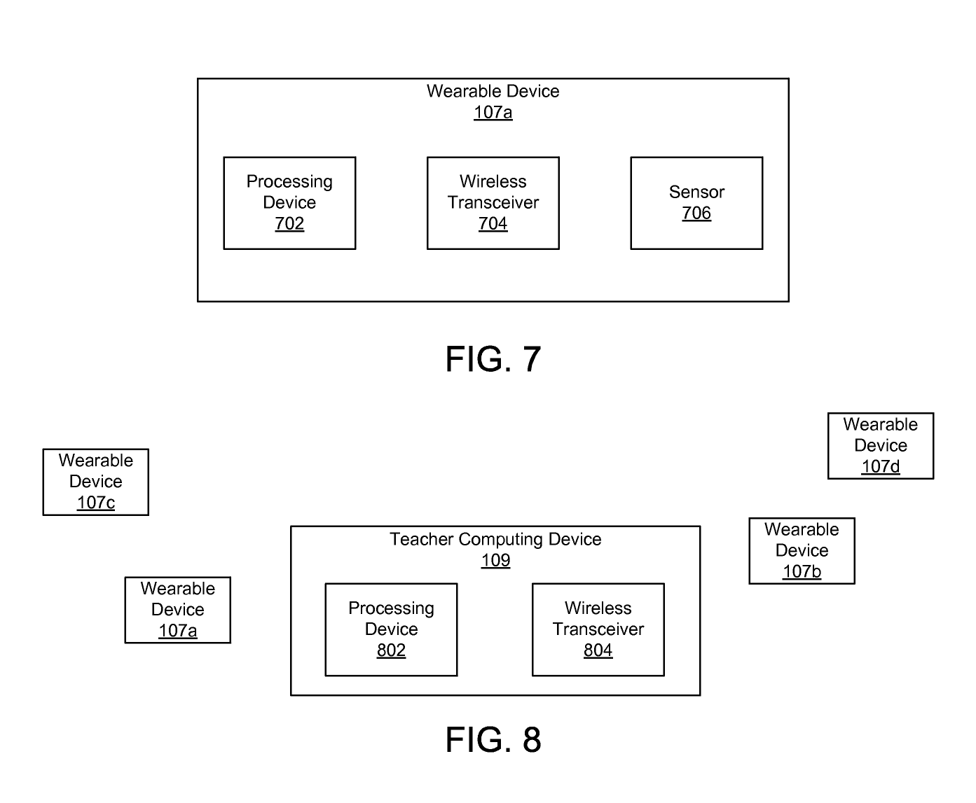

FIG. 7 illustrates a block diagram of the wearable device 107a in accordance with an embodiment. In various embodiments, the wearable device 107a includes a processing device 702, a wireless transceiver 704, and a sensor 706. In some embodiments, the wireless transceiver 704 is a radio frequency (RF) transceiver, such as an IQRF™ transceiver, or the like. In some embodiments, the sensor 706 includes a pulse sensor, a temperature sensor, a sound sensor, a light sensor, or the like. In various embodiments, the wearable device 107a includes multiple sensors in addition to the sensor 706. In some embodiments, the wireless transceiver 704 and the sensor 706 are connected to the processing device 702 for communicating data with the processing device 702.

FIG. 8 illustrates an interaction among wearable devices 107a, 107b, 107c, and 107d and the teacher computing device 109 in accordance with an embodiment. In various embodiments, each of the wearable devices 107a, 107b, 107c, and 107d has a same configuration, such as the configuration of the wearable device 107a shown in the embodiment of FIG. 7. With reference to FIGS. 7 and 8, in various embodiments, each of the wearable devices 107a, 107b, 107c, and 107d is worn or held by a corresponding student. A system with such student-worn wearable devices allows, for example, for student monitoring and for aiding in student safety. For example, in some instances, educators need to be able to guarantee student safety during school hours in a classroom and during numerous trips outside of the classroom. In various embodiments, the use of the wearable devices 107a, 107b, 107c, and 107d allows for tracking the students to the level of knowing with accuracy where all students are on a one-minute time scale. Such embodiments are advantageous, for example, at times when students may be out of direct vision of a teacher or if teachers needs to focus their attention more narrowly than an entire group and still want to keep track of all the students.

With reference to FIGS. 1, 2, 7, and 8, in various embodiments the wearable devices 107a, 107b, 107c, and 107d are configured to monitor each other while being monitored by the teacher computing device 109. In various embodiments, each of the wearable devices 107a, 107b, 107c, and 107d is worn, for example, on the wrist of a corresponding student, and are connected to each other wirelessly, such as by using the wireless transceiver 704 in each device, to form a mesh network. Also, in various embodiments, the teacher computing device 109 includes a processing device 802 and a wireless transceiver 804 for monitoring the wearable devices 107a, 107b, 107c, and 107d by receiving signals from the wearable devices 107a, 107b, 107c, and 107d with the wireless transceiver 804. In some embodiments, the teacher computing device 109 include a smart phone, or the like, and the wireless transceiver 804 is incorporated into a phone case that is USB-connected to the smart phone running an application for displaying results of the monitoring of the wearable devices 107a, 107b, 107c, and 107d. In some embodiments, all wearable devices, such as the wearable devices 107a, 107b, 107c, and 107d, include interconnected wireless transceivers, such as the wireless transceiver 704, that send data about their distance from all connected wearable devices through a mesh network created by the wearable devices to the teacher computing device 109, which monitors the group of wearable devices.

In various embodiments, each of the wearable devices 107a, 107b, 107c, and 107d serves as a node in a mesh network. In some embodiments, a maximum connection distance between nodes in the mesh network is, for example, up to 850 m, meaning that the system has the ability to monitor nodes at a distance, which provides added security in an alarm situation. Also, since in various embodiments each node in the mesh network seeks to connect with many others, reliability is greater than other methods which rely on each node connecting solely to a master node. In various embodiments, the wearable devices 107a, 107b, 107c, and 107d are configured to determine a distance between each other and/or from the teacher computing device 109 and to report the distance to the teacher computing device 109.

In some embodiments, each of the wearable devices 107a, 107b, 107c, and 107d is powered by a built-in rechargeable battery that will last for several days of continuous use. In order to minimize the time required for device management, some embodiments include a charging hub/storage rack where wearable devices not in use can be quickly and easily set to be charged and stored together. The charging of the wearable devices 107a, 107b, 107c, and 107d in some embodiments is performed using wireless inductive charging or a direct contact system, and in some embodiments the wearable devices 107a, 107b, 107c, and 107d and/or the charging hub are configured to alert a teacher if a wearable device is improperly connected to a charging mechanism by noticing, for example, that all wearable devices but one are currently charging. In some embodiments, students are able to remove their wearable devices and place them on charging pads and a magnet ensures alignment for charging.

In some embodiments, the wireless transceiver of each of the wearable devices 107a, 107b, 107c, and 107d, such as the wireless transceiver 704a, includes software for causing the wireless transceiver 704a to perform node discovery and routing to establish the wireless mesh network and route data through the wireless mesh network. Some embodiments allow for programming the wearable devices 107a, 107b, 107c, and 107d over the air for software updates. In some embodiments, each of the wearable devices 107a, 107b, 107c, and 107d has a reset button that is configured to be pressed with a paper clip to prevent unintended operation by a wearer, which will reboot the wearable device to clear any error condition that might occur, such as inability to connect to a mesh network.

In various embodiments, each of the recording devices 102a and 102b includes a wireless transceiver, such as the wireless transceiver 209 of the recording device 102a, for receiving transmissions from the wearable devices 107a, 107b, 107c, and 107d, such as from the wireless transceiver 704 of the wearable device 107a. By incorporating a wireless transceiver within each recording device, such as the wireless transceiver 209 in the recording device 102a, it is possible to determine which recording device is closest to each student wearing a wearable device, such as the wearable device 107a, at any given time. For example, in some embodiments, the recording device 102a is configured to determine distances to the wearable devices 107a, 107b, 107c, and 107d based on information about a web of connections between the wearable devices 107a, 107b, 107c, and 107d and/or signal strengths of signals received from the wearable devices 107a, 107b, 107c, and 107d.

In various embodiments, the recording device 102a is configured to tag video files with information about students with wearable devices, such as the wearable device 107a, that are within a specified distance of the recording device 102a during capture of the video data for the video file based on distance information determined from transmissions from the wearable devices. The tags for the video files could then be provided from the recording device 102a to the remote server 110. In some such embodiments, a user could then use a user device, such as the user device 120a, to specify a student's name and a time to the remote server 110 and be given the video files from the remote server 110 that are most likely to capture the student at that time based on the tags associated with the video files.

In some embodiments, the recording device 102a is configured to determine both a distance from each of the wearable devices 107a, 107b, 107c, and 107d and also a position of each of the wearable devices 107a, 107b, 107c, and 107d based on signals received from the wearable devices 107a, 107b, 107c, and 107d. Also, in various embodiments, the teacher computing device 109 is configured to determine both a distance from each of the wearable devices 107a, 107b, 107c, and 107d and also a position of each of the wearable devices 107a, 107b, 107c, and 107d based on signals received from the wearable devices 107a, 107b, 107c, and 107d. With the teacher computing device 109 as the origin, in various embodiments each of the wearable devices 107a, 107b, 107c, and 107d is plotted as an (x,y) coordinate on a map on a display screen of the teacher computing device 109.

In some embodiments, the teacher computing device 109 includes an application that produces alerts for the teacher based on the signals received from the wearable devices 107a, 107b, 107c, and 107d. In some embodiments, based on safety procedures, the teacher computing device 109 propagates such alerts to devices of other teachers or caretakers. In various embodiments, the teacher computing device 109 is configured to (1) display a list of students under the supervision of the teacher; (2) show how far away each student is from the teacher based on the signals received from wearable devices, such as the wearable devices 107a, 107b, 107c, and 107d; (3) set a maximum distance that a wearable device, such as the wearable devices 107a, 107b, 107c, and 107d, is allowed to be from the teacher computing device 109 and trigger an alert when that distance is exceeded; (4) continue to track such a wearable device past the allowed maximum distance until that distance exceeds a physical ability of the hardware to establish a connection; (5) pull up a safety profile for each student, including lists or procedures for specific needs of each student; and/or (6) upload data, such as the position of each of the wearable devices 107a, 107b, 107c, and 107d at various times, alerts, or the like, to the remote server 110 for indexing and analysis.

In some embodiments, the recording devices 102a and 102b are able to store several days of video files, and are designed to record video during the daytime and upload it to the remote server 110 at night. In some embodiments, video and audio post-processing algorithms are executed on the remote server 110 to build a database of inferences about the video and audio data as well as improve its quality and/or change its format. Examples include facial recognition, low pass filtering, and combining multiple video files into one file. In some embodiments, the remote server 110 supports specialized video and audio processing software and hardware to efficiently execute computer vision and audio processing algorithms on the video files.

In some embodiments, the recording devices 102a and 102b buffer video files until they are downloaded by the remote server 110, at which point they may be deleted by the recording devices 102a and 102b. In some embodiments, the video files may also be deleted by the recording devices 102a and 102b when those recording devices becomes too full by, for example, deleting the oldest video files first. In some embodiments, video post-processing is performed on-board the recording devices 102a and 102b to identify video files that contain movement to be added to video motion lists. In some embodiments, the remote server 110 uses the video motion lists from the recording devices 102a and 102b and a prioritized list of timestamps of useful content provided by an Internet-based application to create a prioritized list of video files that should be downloaded to the remote server 110. In some embodiments, if files are not present on the remote server 110, then a user or application may request that they are downloaded from the recording devices 102a and 102b, assuming they have not been deleted. In various embodiments, security is maintained by protecting data in transit over the network 130 using encryption.

In various embodiments, applications on the Internet are able to access video files and meta-data from the remote server 110. For example, notes created by an educator in a web application on the user device 120a might trigger automation in the cloud to request and transfer data securely from the remote server 110 into a cloud computing platform, such as the computing and storage system 140, to enrich the note with a video clip and/or information gathered by automatically post-processing the video on the remote server 110.

In some embodiments, an API is used to transport video files from the remote server 110 securely into the computing and storage system 140. In some embodiments, the remote server runs an HTTP Secure (HTTPS) server process that accepts requests from user devices, such as the user devices 120a and 120b, to transfer video files to the computing and storage system 140. In various embodiments, transport layer security (TLS) or secure sockets layer (SSL) protocols are used to protect data during transmission. In some embodiments, advanced encryption standard (AES) JavaScript object notation (JSON) web tokens are used to authenticate API accesses to the HTTPS server. In some embodiments, each API call includes a token and, on the server side, a list of valid tokens is used to authenticate and authorize access. In some embodiments, tokens are initially shared over a private channel or offline. In some embodiments, the remote server 110 maintains detailed audit logs are containing access information, so that an administrator can audit who accessed what files and when.

In some embodiments, the API supported by the HTTPS server program running on the remote server 110 supports a GET command, such as GET/recording_device/_search that can be issued from user devices, such as the user devices 120a and 120b, to allow a user to search for recordings by, for example, classroom name, camera ID, or combination of the two. In some embodiments, the GET command accepts parameters including classroom_name to specify a classroom name and camera_id to specify a camera ID. In some embodiments, a reply to the GET command includes a list of video recordings from the specified cameras for the specified classroom.

In some embodiments, the API supported by the HTTPS server program running on the remote server 110 supports a POST command, such as POST /recording_device/<classroom-name>/<camera-id>/<timestamp>/_upload, that can be issued from user devices, such as the user devices 120a and 120b, to cause the remote server 110 to transmit video files that correspond to the parameters specified in the POST command over the network 130 to the computing and storage system 140. In various embodiments, the command is a hypertext transfer protocol (HTTP) POST command. In various embodiments, remote server 110 returns response 200 to the requesting user device if the video files are transferred to the computing and storage system 140.

The systems and methods as described in the present disclosure may be used to provide various features related to a learning environment. The following are various examples of implementations of the systems and methods described herein. While many of the below functions are discussed with respect to the remote server 110, in various embodiments the same functions are able to be performed by the computing and storage system 140, which may be, for example, a cloud computing system.

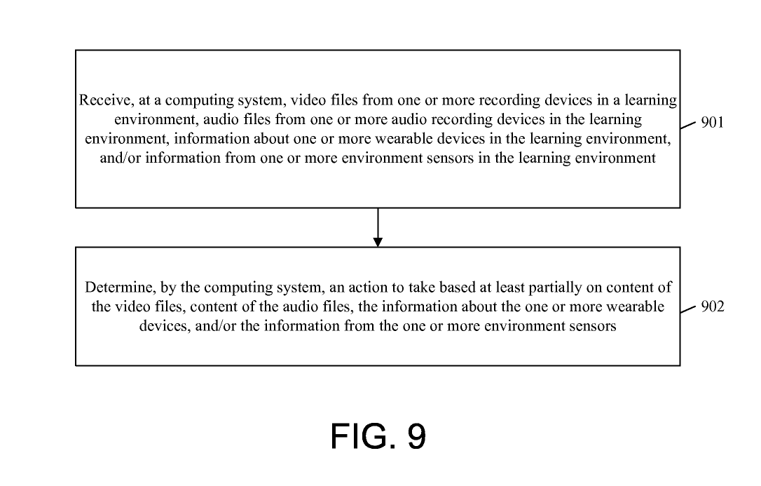

FIG. 9 illustrates a flowchart of a method in accordance with various embodiments. With reference to FIGS. 1, 2, and 4-9, in step 901, a computing system, such as the computing system 118 with the remote server 110, receives video files from one or more recording devices, such as the recording devices 102a and 102b, in a learning environment, audio files from one or more audio recording devices, such as the audio recording devices 104a and 104b, in the learning environment, information about one or more wearable devices, such as the wearable devices 107a and 107b, in the learning environment, and/or information from one or more environment sensors, such as the environment sensor 106, in the learning environment. In step 902, the computing system 118 including the remote server 110 determines an action to take based at least partially on content of the video files, content of the audio files, the information about the one or more wearable devices, and/or the information from the one or more environment sensors

In various embodiments, the remote server 110 is configured to provide for emotional analysis of one or more students or teachers in the classroom. For example, in various embodiments the remote server 110 is configured to analyze faces and the behavior of people in the learning environment 101 using the downloaded video files to gauge an emotional status of a person in the learning environment 101, and also how the emotional status changes based on an impact of different locations or spaces in the learning environment 101, interactions with other students and teachers, and/or other activities.

In some embodiments, the remote server 110 is configured to determine how often students interact with one another, based on the video files and/or audio files. For example, in some embodiments the remote server 110 is configured to perform facial recognition on the video files and/or voice recognition on the audio files to determine students who are interacting with each other such as facing each other or talking to each other.

In various embodiments, the remote server 110 is configured to determine, based on the video files and/or audio files, which students are most talkative, and analyze how talkative students are compared to other students. For example, in some embodiments the remote server 110 is configured to perform facial recognition on the video files and/or voice recognition on the audio files to determine students that are talking based on a movement of their mouths or a detection of their voice and to record an amount of time that each student is talking. Also, in some embodiments, the remote server 110 then sorts the amount of time of talking that has been determined for each student and generates a report of the sorted student names along with the corresponding amount of time of talking to send to the teacher computing device 109 for the teacher to review.

In various embodiments, the system 100 is usable by teachers to reflect on their own teaching, and to determine what the student experience is like during the teaching by, for example, reviewing specified video files and/or audio files. In various embodiments, the system 100 is usable as part of an interactive lesson. For example, a teacher may engage the students and get feedback, such as a video or audio indicating emotion, allowing the teacher to drive forward with the lesson in an optimal manner. In some embodiments, the system 100 is usable to record events useful for playing back later. For example, such a feature may be useful in music lessons, drama lessons, or the like, to allow students and teachers to study performance and see what the students missed by, for example, reviewing specified video files and/or audio files.

In various embodiments, the system 100 is usable to engage students who are not in the learning environment 101, such as allowing students located remotely from the learning environment 101 to connect remotely and view video and/or audio from the learning environment 101. In some embodiments, the system 100 is useable to study learning styles. For example, students learn in different ways, and teachers and experts can observe the behavior of the students by, for example, reviewing the video files and/or audio files, and make recommendations that influence lesson plans.

In various embodiments, the remote server 110 is configured to provide automatic student engagement analysis, such as determining whether a student is distracted, engaged, or the like based on the video files and/or audio files. For example, in some embodiments the remote server 110 is configured to perform facial recognition on the video files and/or voice recognition on the audio files to determine whether a student is distracted or engaged. In some embodiments, occupational therapists may use the system 100 for analysis. In various embodiments, the system 100 is usable to analyze time spent on various activities. In some embodiments, such tracking is automatic by the remote server 110 where the remote server 110 is configured to analyze time spent by students on various activities based on the content of the video files and/or audio files.

In various embodiments, the system 100 is usable to connect people between learning environments. In some embodiments, the system 100 is usable for behavior documentation. For example, in various embodiments, the remote server 110 is configured to automatically prepare reports to show the parents what happened in the learning environment 101, how often a problem behavior is happening, and can show good moments in the learning environment 101 based on the video files and/or audio files. In some embodiments, the system 100 is usable to view conflict resolution and allow a user to revisit video and/or audio of a conflict situation after the fact.

In various embodiments, the system 100 is usable to generate a portfolio of videos. In some embodiments, the portfolio is generated automatically by the remote server 110 based on playlists or may be manually created by a teacher. In various embodiments, system 100 is usable to capture non-shaky video and to capture video at advantageous angles though the positioning of the recording devices 102a and 102b in the learning environment 101. In various embodiments, the system 100 is usable by a teacher to determine how well students are doing in class. In some such embodiments, student success is automatically tracked by the remote server 110 based on the video files and/or audio files. For example, in some such embodiments, the remote server 110 is configured to determine how accurately students are pronouncing words based on an analysis of the audio files.

In various embodiments, the system 100 is usable by a teacher to file tickets. In some embodiments, the system 100 is usable by school personnel to check storage, to check if anything in the learning environment 101 is broken, or the like. In various embodiments, the system 100 is usable for preparing marketing campaigns. In some embodiments, the system 100 is usable for real-time reviews of events in the learning environment 101 by reviewing video and/or audio captured in the learning environment 101. In various embodiments, the system 100 is usable to check students for potential problems, such as by listening to voices and/or analyzing facial expressions to prevent events before they happen. In such some embodiments, the remote server 110 is configured to analyze voices in audio files and/or analyze facial expressions in video files to flag or predict potential problem events.

In various embodiments, the system 100 is usable by experts to reflect on events in the learning environment 101, so as to provide transparency as to events occurring in the learning environment. In some embodiments, the system 100 is usable in any form of reflection of events in the learning environment 101. In various embodiments, the system 100 is usable to measure stress. For example, in some embodiments, the remote server 110 is configured to determine a level of stress of the students based on the contents of the video files and/or audio files. In various embodiments, the system 100 is usable to help teachers monitor students, such as to indicate whether the students are on task, or the like. For example, if a teacher is in a one-on-one session, the teacher may receive an alert on the teacher computing device 109 when another student or group of students is off-task. As another example, analysis of the audio files it may help teachers and students be generally aware of the volume of their own speech. In various embodiments, the remote server 110 is configured to analyze when a group of students is off task based on an analysis of the video files and/or audio files. In some embodiments, the remote server 110 is configured to provide a report of the volume of speech of each student to the teacher computing device 109 based on the contents of the video files and/or audio files.

In various embodiments, the system 100 is usable to capture a learning moment and to link to goals and activities related to the learning moment. In some embodiments, the system 100 is usable to document student questions. For example, in some such embodiments, the remote server 110 is configured to automatically document student questions based on an analysis of the video files and/or audio files. In various embodiments, the system 100 is usable to generate a travel map that illustrates movement of students in the learning environment 101 over time. In some such embodiments, the remote server 110 is configured to automatically generate the travel map illustrating movement of students in the learning environment 101 over time based on the video files, audio files, and/or information on position gathered from a monitoring of wearable devices, such as the wearable devices 107a and 107b.

In various embodiments, the system 100 is usable for physical and emotional state tracking. For example, in some such embodiments, the remote server 110 is configured to automatically track the emotional and/or physical state of students based on the video files and/or audio files and/or other feedback from the students through sensors or input devices. In some embodiments, the system 100 is usable to provide automatic or manual class status updates. In some embodiments, the system 100 is usable for daily schedule tracking. In various embodiments, the system 100 is usable for attendance tracking. For example, in some embodiments, the remote server 110 is configured to perform attendance tracking based on facial recognition using the video files, voice recognition using the audio files, and/or information from the wearable devices, such as the wearable devices 107a and 107b.

In various embodiments, the system 100 is usable to help offline employees communicate with teachers without having to visit the learning environment 101. In various embodiments, the system 100 is usable to determine trends, such as measuring states of flow, allowing the teacher to target a certain percentage of work time for flow, or the like. In some embodiments, the remote server 110 is configured to automatically determine trends in the classroom based on the video files and/or audio files. In some embodiments, the system 100 is usable for noise cancelling from one side of the learning environment 101 to the other. For example, in some embodiments, the recording devices 102a and 102b are placed on opposite halves of the learning environment 101 and are each equipped with noise cancelling devices to cancel noises originating from the other half of the learning environment 101.

In various embodiments, the system 100 is usable to track certain words, such as, for example, how many times a name is said in the learning environment 101. In some such embodiments, the remote server 110 is configured to track certain words and provide reports as to how many times tracked words are said based on the video files and/or audio files. In various embodiments, the system 100 is usable to determine if changes to the classroom are working or having an impact. In some embodiments, the system 100 is usable by personnel such as janitors to determine if the learning environment 101 needs to be cleaned based on a review of the video files. In various embodiments, the system 100 is usable to identify social roles of students, such as to identify students who starts events or conflicts.

In various embodiments, the system 100 is usable to monitor and unlock sound on a tablet computing device or other mobile device. In various embodiments, the system 100 is usable to detect the mixture of foreign language words in English speech. For example, in some such embodiments the remote server 110 is configured to perform analysis of the video files and/or audio files to provide a count of a number of times that foreign language words are spoken within English statements. In various embodiments, the system 100 is usable to determine what quiet students are doing in the learning environment 101. In some embodiments, the system 100 is usable to detect distractions in the learning environment 101. In various embodiments, the system 100 is usable for film-making and art projects, such as by using raw footage of the video files in a film or other project. In some embodiments, the system 100 is usable to detect and/or document bullying in the learning environment 101.

In various embodiments, the system 100 is usable to detect light levels and/or other environmental factors in the learning environment 101, and to check for correlations with other events in the learning environment 101. For example, in some such embodiments, the environment sensor 106 includes a light sensor and transmits information about the light level in the learning environment 101 to the remote server 110, and the remote server 110 is configured to analyze video files and/or audio files for events occurring at different light levels. Also, in some such embodiments, the environment sensor 106 includes a temperature sensor and transmits information about the temperature in the learning environment 101 to the remote server 110, and the remote server 110 is configured to analyze video files and/or audio files for events occurring during times with different temperature levels.

In various embodiments, the system 100 is usable to optimize traffic flow. In some embodiments, the system 100 is usable to track student steps in the learning environment 101. For example, in some such embodiments, the remote server 110 is configured to track students in the learning environment 101 based on facial recognition of the video files, voice recognition of the audio files, and/or position information determined based on signals from the wearable devices, such as the wearable devices 107a and 107b. In various embodiments, the remote server 110 is configured to perform facial recognition using the video files to check for boredom by the students. In various embodiments, the system 100 is usable to create heat maps of quiet and loud spots in the learning environment 101. For example, in some such embodiments, the remote server 110 is configured to generate a heat map of quiet and loud spots in the learning environment 101 based on the audio files.

In various embodiments, the system 100 is usable to predict and gamble on class behavior. For example, in some such embodiments, the system 100 is usable to play bingo with video footage from the learning environment 101. In some embodiments, the system 100 is usable for locating any Bluetooth enabled device in the learning environment 101. In some embodiments, the system 100 is usable to determine teacher time spent on various tasks, such as with particular students.

In various embodiments, the recording device 102a is a hardware device for the learning environment 101 that captures high quality video and audio to produce rich, accessible, digital media that can be used for a variety of purposes related to learning environment operations. In some embodiments, video files created by the recording device 102a are accessible via a software search and browsing interface, and the recording device 102a supplies video and audio artifacts that can be utilized to better understand student behavior, to inform school facility and operational strategies, and conduct research on classroom and curricular dynamics.

In various embodiments, the recording device 102a provides a passive, non-intrusive window into the learning environment 101 that enables teachers, operations personnel, and research personnel to better experience and understand events in the learning environment 101, population trends, and learning moments while remote from the learning environment 101. In various embodiments, the user devices 120a and 120b provide access to raw and indexed video from the recording device 102a stored at the remote server 110, which allows users of the user devices 120a and 120b to search for and find video clips associated with relevant happenings in the learning environment 101 for use in personalized lesson plan development, sharing with parents, and/or other learning research studies.

In various embodiments, the user devices 120a and 120b provide an intuitive, easy-to-use interface to find and retrieve relevant video clips captured by the recording devices 102a and 102b for review by teachers, operations personnel, research personnel, administrators, parents, students, or the like. In various embodiments, the recording device 102a has a non-intrusive presence in the learning environment 101 and the remote server 110 provides reliable, secure, and logged access to high quality video captured by the recording device 102a that is useful to teachers in the understanding and learning aspects of a learning cycle. In some embodiments, the video clips captured by the recording devices 102a and 102b enable research personnel to conduct behavior, spatial, and population studies regarding the learning environment 101.

In various embodiments, videos that are generated from different recording devices in one learning environment 101, such as the recording devices 102a and 102b, are time synchronized. In some embodiments, the remote server 110 takes advantage of the time synchronization of the videos recorded by the individual cameras, such as the cameras 207a, 207b, and 207b, of a given recording device, such as the recording device 102a, and those of neighboring recording devices, such as the recording device 102b, in the learning environment 101 to enable low-friction switching between multiple video streams of a same subject and/or event.

In various embodiments, the recording device 102a is configured to pre-tag video with relevant location meta-data to enable efficient retrieval and research. For example, in some embodiments, videos recorded by the individual cameras 207a, 207b, and 207c of the recording device 102a are tagged by the corresponding processing devices 204a, 204b, and 204c with an identifier of the learning environment 101, a unit identifier of the recording device 102a, and a camera name or number for the camera capturing the video. In some embodiments, the unit identifiers are posted on the physical recording devices 102a and 102b. In some embodiments, the recording device 102a is configured to pre-tag video with relevant program meta-data to enable efficient retrieval and research. For example, in some embodiments, videos recorded by the recording device 102a are tagged with program designations, such as lower elementary, upper elementary, middle school, after school, or the like, associated with the subjects recorded based on location and calendar data.

In various embodiments, the recording device 102a is configured to pre-tag video with relevant meta-data about motion to enable efficient retrieval and research. For example, in some embodiments, the processing devices 204a, 204b, and 204c of the recording device 102a are configured to analyze videos captured by the corresponding cameras 207a, 207b, and 207c for motion and to tag video files of the videos with an indicator to indicate whether motion has been detected in the video. In various embodiments, the recording device 102a is configured to pre-tag video with relevant meta-data, such as a count of individuals in the video or the like, to enable efficient retrieval and research. For example, in some embodiments, each of the processing devices 204a, 204b, and 204c of the recording device 102a are configured to perform facial recognition on video files and to tag each of the video files with a number of individuals present in the video of the video file based on the result of the facial recognition.

In various embodiments, the recording device 102a is configured to pre-tag videos with relevant meta-data, such as student identifiers or the like, to enable efficient retrieval and research. For example, in some embodiments, each of the processing devices 204a, 204b, and 204c of the recording device 102a are configured to perform facial recognition on video files and to tag each of the video files with student identifiers of individuals present in the video in the video file based on the result of the facial recognition. In various embodiments, the recording device 102a is configured to pre-tag videos with relevant calendar event meta-data to enable efficient retrieval and research. For example, in some embodiments, each of the processing devices 204a, 204b, and 204c of the recording device 102a are configured to tag each recorded video file with calendar events that coincide with a recording time of the video file. Example of calendar events include, for example, playlist time, transitions, and co-curriculars based on a pre-set calendar.

In various embodiments, the recording device 102a is configured to pre-tag videos with relevant auto-detected classroom event meta-data to enable efficient retrieval and research. For example, in some embodiments, each of the processing devices 204a, 204b, and 204c of the recording device 102a are configured to tag each recorded video file with information about auto-detected events that occurred during the video clip in the video file. Examples of event tags include, for example, noisy moments, quiet moments, and peer-to-peer interaction moments, that are tagged by the processing devices 204a, 204b, and 204c based on the results of audio level detection and/or facial recognition of each of the video files.

In various embodiments, the recording device 102a is configured to allow a teacher to indicate to that a memorable moment is occurring in the learning environment 101 and to tag one or more video files at that time to indicate the video files are associated with the memorable moment, which enables easy retrieval of the associated video files at a later time. For example, in various embodiments, the recording device 102a is configured to receive a signal from the teacher computing device 109 indicating that a memorable moment is occurring, and to tag video clips currently being recorded to associate them with the memorable moment. In some embodiments, the teacher computing device 109 includes a user interface for specifying such a memorable moment, which may be, for example, a user interface on a laptop, tablet, smart phone, or the like. In some embodiments, the teacher computing device 109 communicates with the remote server 110 to indicate a time of a memorable moment, and the remote server 110 then correlates all recordings from recording devices, such as the recording device 102a, made around and during that time with the memorable moment using a periodic batch process.

In various embodiments, the recording device 102a is configured to allow a teacher to explicitly save a teacher-produced learning environment moment by commanding the recording device 102a to“start recording” and “stop recording.” For example, in some embodiments, the teacher computing device 109 allows the teacher to indicate to the recording device 102a in the learning environment 101 that the teacher would like to create a retrievable video clip by “starting” and “stopping” a recording. In some embodiments, the teacher computing device 109 includes a user interface for specifying the starting and stopping of recording of the user-defined video clip, which may be, for example, a user interface on a laptop, tablet, smart phone, or the like. In various embodiments, the recording device 102a is configured to add meta-data to videos already being recorded to define the user-defined video clip for the teacher-produced learning environment moment based on the start and stop recording indications. In some embodiments, the teacher computing device 109 sends the start and stop recording commands to both the recording device 102a and the recording device 102b at the same time and the recording devices 102a and 102b perform the same operations in response to the commands.

In various embodiments, the recording device 102a is configured to allow students to explicitly save a student-produced learning environment moment by commanding the recording device 102a to“start recording” and “stop recording.” For example, in some embodiments, the student computing device 108a allows a student to indicate to the recording device 102a in the learning environment 101 that a student would like to create a retrievable video clip by “starting” and “stopping” a recording. In some embodiments, the student computing device 108a includes a user interface for specifying the starting and stopping of recording of the user-defined video clip, which may be, for example, a user interface on a laptop, tablet, smart phone, or the like. In various embodiments, the recording device 102a is configured to add meta-data to videos already being recorded to define the user-defined video clip for the student-produced learning environment moment based on the start and stop recording indications. In some embodiments, the teacher computing device 109 sends the start and stop recording commands to both the recording device 102a and the recording device 102b at the same time and the recording devices 102a and 102b perform the same operations in response to the commands.

In various embodiments, the user device 120a is configured to provide a viewing portal for viewing videos that allows for easy transition between times, cameras, and learning environments without complicated manual navigation. For example, in some embodiments, the user device 120a displays an interface accessible by a web browser that provides a user interface to the remote server 110 that allows a user to quickly find, retrieve, view, and transition between videos based on timestamp and location, such as an identifier of a learning environment, an identifier of a recording device, and an identifier of a camera. In some embodiments, the user interface is also designed to allow for filtering or searching by additional meta-data fields, such as fields indicating students, events, or the like, in video files.

In various embodiments, the user device 120a and the remote server 110 are configured to provide video consumers with the ability to view video files from multiple cameras, such as the cameras 207a, 207b, and 207c of the recording device 102a, as a single or complete video clip. For example, in various embodiments, a user interface on the user device 120a provides an option that is selectable through the user interface to concurrently view video files recorded from multiple cameras as one stitched-together video clip, such as a video that is 2,880 pixels wide.

In various embodiments, the user device 120a and the remote server 110 are configured to provide users with the ability to view video files from a same learning environment at different angles simultaneously. For example, in various embodiments, a user interface on the user device 120a provides an option that is selectable through the user interface to concurrently view videos files recorded from multiple recording devices in a learning environment, such as from the recording devices 102a and 102b in the learning environment 101.

In various embodiments, the user device 120a and the remote server 110 are configured to provide users with the ability to find recorded video files by filtering or searching for video files associated with a specific student or group of students. For example, in various embodiments, a user interface on the user device 120a provides an option that is selectable through the user interface to find video files at the remote server 110 that include specific students or groups of students via a search interface that allows for specifying student names. In some embodiments, tags associated with the video files are searched for the specified student names to return video files that include a student or group of students.

In various embodiments, the user device 120a and the remote server 110 are configured to provide users with the ability to find recorded video files by filtering or searching for video files associated with a specific learning environment event, such as a calendar-based event or the like. For example, in various embodiments, a user interface on the user device 120a provides an option that is selectable through the user interface to find video files that are associated with specific learning environment events via a search interface that allows a user to specify labels for events, such a playlist time, a transition, and/or co-curricular event. In some embodiments, tags associated with the video files are searched for the learning environment events to return video files that are associated with the events.

In various embodiments, the teacher computing device 109 and the remote server 110 are configured to provide a teacher with the ability to have an instant replay to quickly understand a learning environment event that recently took place. For example, in various embodiments, the remote server 110 makes videos older than five minutes available for viewing and discoverable by location and timestamp values through a user interface on the teacher computing device 109.

In various embodiments, the teacher computing device 109 and the remote server 110 are configured to provide a teacher with the ability to share student-specific video files with parents in either positive or constructive feedback communications. For example, in various embodiments, the teacher computing device 109 provides a user interface that allows a teacher to attach a video file or series of video files from the remote server 110 to a learning update e-mail to a parent or into a learning plan for a student for later sharing during a family conference.

In various embodiments, the teacher computing device 109 and the remote server 110 are configured to provide a teacher with the ability to associate student-related video files with a student's personal learning plan goal as an expression of student work output or progress. For example, in various embodiments, the teacher computing device 109 provides a user interface that allows a teacher to associate a video file or series of videos files from the remote server 110 to a student's personal learning plan goal and to provide an assessment of that personal learning plan goal.

In various embodiments, the user device 120a and the remote server 110 are configured to provide users with the ability to tag a set of video files in a batch-like manner with meta-data to enable further research. For example, in various embodiments, a user interface on the user device 120a provides an option to batch associate meta-data tags with a set of video files at the remote server 110 by selecting multiple video files to apply meta-data tags to via tag fields. In some embodiments, a researcher could do a study of a learning environment to track who interacts with whom in the learning environment for a month, and could request that all video files be tagged with meta-data indicating students interacting with each other in the videos. In some embodiments, a backend transcoder component accepts workplans, so that a frontend can request videos concatenated in time.

In various embodiments, the user device 120a and the remote server 110 are configured to provide users with the ability to watch videos at quicker speeds to capture insights over longer time periods. For example, in various embodiments, a user interface on the user device 120a provides an option to watch video files from the remote server 110 at accelerated rates, such as 2×, 4×, and 8× speeds.

In various embodiments, the remote server 110 is configured to perform facial recognition on video files to take attendance each day for the learning environment. For example, in various embodiments, the remote server 110 is configured to perform facial recognition on the video files received from the recording devices 102a and 102b to automatically identify students and their identities based on the facial recognition and to record their presence in an attendance database.

In various embodiments, the remote server 110 is configured to provide feedback on how learning environment space is utilized given current furniture and space arrangements. For example, in various embodiments, the remote server 110 is configured to generate a visualized heat-map of how frequently learning environment spaces are utilized by students and teachers in the learning environment based on an analysis of video files recorded across a specified date and/or time range.

In various embodiments, the user device 120a and the remote server 110 are configured to provide users with the ability to find video files that are associated with high or low student emotional states. For example, in various embodiments, the remote server 110 is configured to use facial recognition to automatically identify video files that exhibit students having high and low student emotional states based on their facial expressions. In some such embodiments, the user device 120a provides a user interface that allows such video files to be discoverable from the remote server 110 via a search and/or filter option in the user interface on the user device 120a.

In various embodiments, the user device 120a and the remote server 110 are configured to provide users with the ability to review access patterns, such as accesses specified by individuals with timestamps, for video files. For example, in various embodiments, the user device 120a provides a user interface to access from the remote server 110 a historical log of video file access by indicating, for example, a learning environment identifier, a recording device identifier, and timestamps, as search or filter criteria. In some such embodiments, the historical log includes usernames of accessors, timestamps of access, and a link to the viewed video file for each individual video file accessed or viewed. Also, in some such embodiments, viewing a video file from the historical log also generates a view log entry in the historical log. Various embodiments relate to automatic documentation of learning environment events, such as classroom events, transmitted over the network 130 and stored in the database 114 of the remote server 110, where the database 114 supports a distributed real time notification system and post-processing compute engine. Various embodiments are directed to a method of electronically monitoring, recording, and storing, both securely and efficiently, classroom activities with a view of using such data to improve the learning environment and learning capacity, detect student help requests, and to keep track of any classroom activities that are outside of the norm. In some instances, personalized learning techniques are applied in the classroom and reflection is an important tool used to inform and improve personalized learning plans. In some embodiments, reflection can be improved by documenting conversations during formal student and teacher one-on-one sessions and informal self-documentation involving students capturing classroom events, which is useful to gain insights into the student's own perspective. Also, some embodiments provide the ability to capture important learning moments and send them to parents and to review teacher performance in class guides.

Various embodiments provide a method of automatically and electronically monitoring classroom activities. Some of the tasks that various embodiments carry out include, but are not limited to, identifying persons and their relative location in the classroom; monitoring and recording the frequency and types of interactions among persons in the classroom; recording and using specific data to determine how certain variables in the classroom affect learning capacity; gathering learning analytics from students such as, for example, taking screen-shots of the student computing devices 108a and 108b to monitor what students are working on; post-processing of recorded data such as, for example, voice identification, video and audio quality enhancement, audio transcription, tracking classroom management, semantic analysis including what persons are doing or feeling, and joining semantic data and personalized learning plan data to create inferences.

A method in accordance with various embodiment includes automatically documenting classroom events via various sensing platforms and transmitting the data via an Application Programming Interface (“API”) into the database 114 where the data is stored securely. In some such embodiments, once in the database 114, the data is processed by the processing circuit 112 using a publisher-subscriber pattern, which allows real time workers to respond to any notifications with real time requirements, where real time notification latency is bounded and monitored. In some embodiments, a distributed compute engine of the processing circuit 112 runs scheduled asynchronous parallel processes to post-process data in the database 114. In some embodiments, data access is authenticated and logged at the API level, and audited layers of security are maintained.

Various embodiments include audio, visual, and sensory recording devices, such as the devices in the learning environment 101, that transmit information to the remote server 110 to be stored in the database 114, which may be, for example, a cloud database. In various embodiments, the sensory platforms record information, transmit the information to the remote server 110 using an API where the information is stored in the database 114. In some embodiments, the database 114 is monitored by a publisher/subscriber system running on the processing circuit 112 that immediately notifies real time workers when changes to the database 114 are detected. In some embodiments, distributed real time workers support applications with real time requirements such as help requests from students. In some embodiments, a distributed compute engine running on the processing circuit 112 is flexible and scales asynchronous parallel processes on a schedule to post-process data in the database 114 such as improving the quality of a student's voice recording during a certain event or determining whether a person is in the learning environment 101.

In some embodiments the students and/or teacher are each provided with a wearable sensing device, such as the wearable devices 107a and 107b. The wearable devices 107a and 107b may be worn as, for example, slippers, arm bands, watches, rings, and/or glasses. In some embodiments, each of the wearable devices 107a and 107b collects information regarding the wearer such as pulse, temperature, physical position, interaction with others in the learning environment 101, video and audio and images of points of view of interactions, and/or simple instant input from a student or teacher such as a student's help request. In various embodiments, the collected data is sent from each of the wearable devices 107a and 107b over the network 130 to the remote server 110 to be stored into the database 114, which may be, for example, a cloud database, and distributed real time workers can process notifications and respond accordingly.

In some embodiments, a panoramic audiovisual sensing platform, such as the recording devices 102a and 102b, automatically records classroom events. In various embodiments, the recordings are sent over the network 130 using an API to be stored in the database 114 and the processing circuit 112 runs a distributed compute engine to post-processes the recordings to, for example, improve the quality of a student's voice recording during a certain event. In various embodiments, an environmental sensing platform including environment sensors, such as the environment sensor 106, monitors and records temperature, air quality, and hot-spots of activity in the learning environment 101 and compares those values to a desired level of comfort of students and teachers in the learning environment 101 in an effort to improve learning and capacity constraints. In some embodiments, the remote server 110 is configured to control devices, such as air conditioning or heating units in the learning environment 101, based on values provided from the environment sensor 106 to affect the environment in the learning environment 101.

In some embodiments, a computer-implemented method allows for automatically documenting classroom events using an embedded system, where the embedded system includes a memory and processor that causes the embedded system to carry out the method including recording all classroom events using various sensing platforms, transmitting recordings using API, storing recordings in a cloud database, detecting changes in the recordings using a publisher-subscriber pattern, sending immediate update messages to distributed real time workers, and post-processing recordings on a schedule using compute engines. In some such embodiments, the sensing platforms include panoramic audiovisual sensing platforms, audio array sensing platforms, wearable sensing platforms, mobile devices, and/or environmental sensing platforms.

Methods in accordance with various embodiments allow for documenting anomalies in student performance. Various embodiments allow for real time monitoring of student activities and to gain insight into student performance, where such insight provides a basis for providing recommendations of next steps. For example, various embodiments are directed to a method of electronically monitoring a progress of a student in real-time, determining whether that student is stuck or how their performance compares to the performance of other students, and providing that student with recommendations based on their performance. In some embodiments, the remote server 110 is configured to act as an agent to monitor student performance on assignments taken on student computing devices, such as the student computing devices 108a and 108b, and to intervene when specific metrics of student performance deviate from statistical models. Some embodiments provide a means of providing both qualitative and quantitative analysis of student performance.

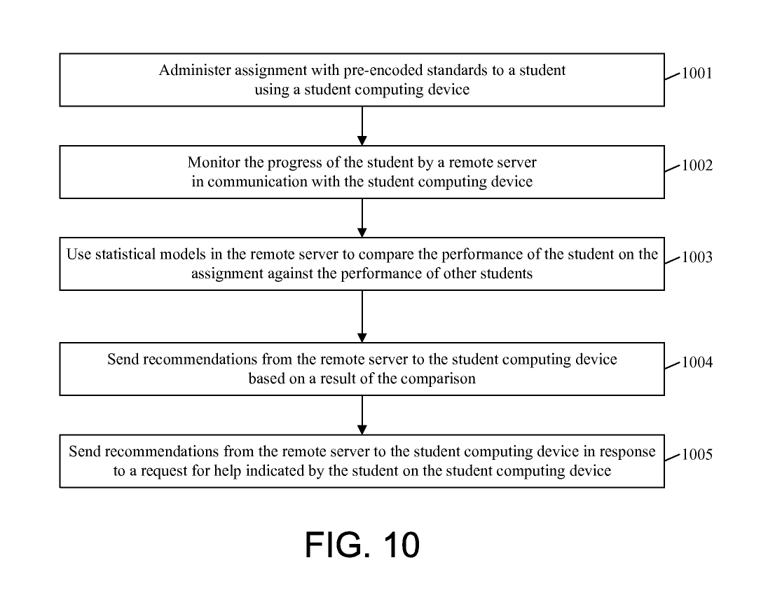

FIG. 10 is a flowchart of a method in accordance with an embodiment for monitoring and gaining insight into student performance and providing recommendations based on the student performance. With reference to FIGS. 1 and 10, in step 1001, an assignment is administered with pre-encoded standards to a student using the student computing device 108a. In various embodiments, the student computing device 108a includes a computer, a tablet device, a smart phone, or the like. In step 1002, the remote server 110 monitors the progress of the student on the assignment by receiving communications from the student computing device 108a over the network 130. In step 1003, the remote server 110 uses statistical models to compare the performance of the student on the assignment against the performance of other students. In step 1004, the remote server 110 sends recommendations to the student computing device 108a based on a result of the comparison. In step 1005, the remote server 110 sends recommendations to the student computing device 108a in response to a request for help indicated by the student on the student computing device 108a.

Thus, in various embodiments, a method provides a means of both quantitative and qualitative analysis of student performance including the steps of (1) administering an assignment with pre-encoded standards via a computerized device; (2) monitoring the student's progress as the student completes the assignment using software; (3) comparing the student's performance to other students' performances using previously created statistical models based on various metrics; and (4) based on the student performance, providing recommendations for next steps, where next steps may include, for example, other assignments, teacher intervention, peer intervention, helpful references, and/or targeted questioning.

In various embodiments, the remote server 110 is configured to create statistical models using various metrics. The statistical models may include, but are not limited to, bayesian surprise models, minimal bounding hyperspheres models, clustering techniques, and/or other probabilistic or geometric techniques used to describe a multidimensional space. Metrics may include, but are not limited to, the time it takes to complete the entire assignment, the time spent on each question, and/or the accuracy of each response.

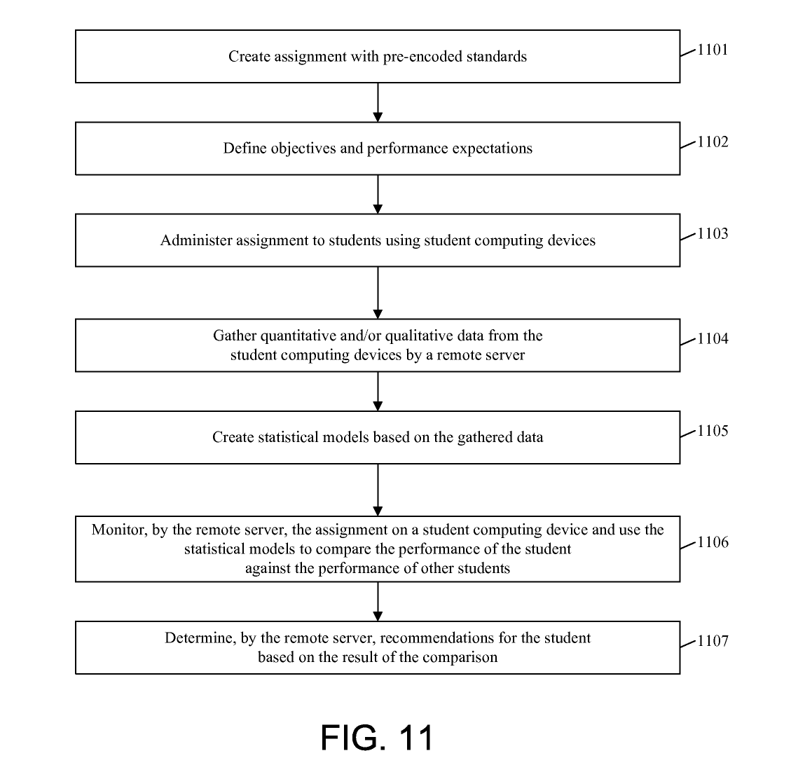

FIG. 11 is a flowchart of a method in accordance with an embodiment. With reference to FIGS. 1 and 11, in step 1101 an assignment is created with pre-encoded standards. In step 1102, objectives and performance expectations are defined for the assignment. In step 1103, the assignment is administered to students using student computing devices, such as the student computing devices 108a and 108b. In step 1104, quantitative and/or qualitative data from the student computing devices, such as the student computing devices 108a and 108b, are gathered by the remote server 110. In step 1105, statistical models are created based on the gathered data. In step 1106, the remote server 110 monitors the assignment being taken by a student on a student computing device, such as the student computing device 108a, and uses the statistical models to compare the performance of the student against the performance of other students. In step 1107 the remote server 110 determines recommendations for the student based on the result of the comparison.

Various embodiments are embodied as a method implemented in a computerized device. In some embodiments, students are able to complete pre-encoded assignments on computerized devices while software monitors their progress in real-time. Also, in some embodiments, algorithms use metrics to compare a student's performances to various statistical models to produce a recommended course of action based on the student's performance.

In some embodiments, the assignment may require an essay response and is graded using a qualitative analysis. For example, a student may complete the assignment on a computerized device, such as the student computing device 108a, and submit the assignment electronically to the teacher computing device 109. In some such embodiments, the teacher receives the assignment at the teacher computing device 109, tags it based on various pre-determined objectives, and sends the tagged assignment to the remote server 110. In various embodiments, the remote server 110 then responds to the teacher and/or the student with recommendations based on the tagged assignment.

In some embodiments, the remote server 110 is configured to monitor a performance of a student while the student is in the process of completing an assignment on a computerized device, such as the student computing device 108a. In some embodiments, the remote server 110 monitors the student's progress as the student is completing the assignment. In various embodiments, the remote server 110 is configured such that if the remote server 110 detects that the student is spending a longer time than is expected to complete a specific question, the remote server 110 intervenes with recommendations such as helpful resources, targeted questioning, and/or some other appropriate recommendation.

In various embodiments, a computer-implemented method of monitoring student performance in real time includes administering an assignment with pre-encoded standards via a computerized device, monitoring the students' progress by use of software as they complete the assignment, comparing the student performance to other students' performances, and intervening with recommendations of next steps based on a result of the comparison. In some embodiments, the recommendations are provided to the student. In some embodiments, the recommendations are provided to the teacher. Also, in some embodiments, recommendations are provided in response to a student's request for help.

Various embodiments allow for providing real-time classroom insights. With reference to FIG. 1, some embodiments provide an automatic notification system that produces output based on real time processing of data collected and stored in the database 114, which may be, for example, a cloud database. Various embodiments provide a method that presents student activity and highlights actions in a way best suited for teacher insight and student learning in a classroom. Various embodiments provide a method to detect specific triggers that include, for example, students working on a same playlist item, students trying to avoid an item in the playlist, students stuck on a particular item in the playlist, and/or students who are distracted. In some such embodiments, based on those triggers, which may be detected using a publisher-subscriber system, appropriate notifications are produced. Various method in accordance with embodiments determine a type of notification to relay, whether audible, visual, or both, based on effectiveness and appropriateness and a priority in which a student's request should be responded to based on a level of urgency. In some embodiments, visual notifications are updated to an events stream when a user logs onto a device, such as the teacher computing device 109, on which an application for receiving notifications is running.

A method in accordance with an embodiment includes automatically producing audible and visual notifications in response to specific triggers. In some embodiments, events in the learning environment 101 are recorded and/or sensed, and information and data regarding the events are transmitted to the remote server 110. In some such embodiments, the remote server 110 is configured to use a publisher-subscriber system to monitor incoming data and to send real-time audible and visual notifications to an events stream on a user's device, such as the teacher computing device 109. In some embodiments, external systems push data to the events stream over the network 130 using an application programming interface. Also, in some embodiments, an event buffer allows unread notifications to be automatically updated to the events stream when an application is launched on the user's device, such as when an application is launched on the teacher computing device 109.

Various embodiments include an electronic device running an application, where a publisher-subscriber system monitors events on the electronic device and pushes audible and visual notifications to an events stream in response to specific triggers. As an example, in some embodiments a student may use a device, such as the student computing device 108a, on which an application is running. In some such embodiments, based on previously collected statistical data it may be determined that at a specific time of day students become distracted. In some such embodiments, the publisher-subscriber system that may be running, for example, on the remote server 110, detects the time of day and pushes a notification to an events stream that may appear, for example, on the student computing device 108a. In some embodiments, an algorithm determines which type of notification, such as audible, visual, or both, is appropriate based on a type of trigger to which the notification is a response.

As another example, in some embodiments a student may turn on a device, such as the student computing device 108a, on which an application is running and an events buffer may then push any unread notifications to an events stream for display by the application. For example, in some such embodiments, the remote server 110 is configured such that when it detects that a student has started working on an item in a student playlist on the student computing device 108a, the remote server 110 sends a notification to the student computing device 108a to notify the student of other students in the classroom who are working on the same item. In some embodiments, a student can request help through a help button displayed on the student computing device 108a, and a notification is then sent to the teacher's event stream in an application running on the teacher computing device 109 to notify the teacher that the student has requested help. In some embodiments, an algorithm ranks events, such as multiple requests for help from different students, in order to prioritize teacher interactions.

A computer implemented method in accordance with various embodiments allows for producing real-time audio and visual notifications and includes running an application on an electronic device, updating notifications in order of importance on an event stream using an event buffer, detecting a trigger in real-time using a publisher-subscriber system, and producing audio and/or visual notifications based on a type of the trigger.

Various embodiments provide a method of capturing learning artifacts in hypermedia form. For example, some embodiments provide a document creation program that incorporates a method of capturing and storing learning artifacts in locations accessible through tree structured links. Various embodiments are directed to a method of storing and retrieving student activities and resources using tree structured links. In some such embodiments, those links are short, stable, and easy to remember and are different from uniform resource locators (URLs). Various embodiments provide a means of specifying which notes within an activity are visible to certain users. Also, some embodiments provide a method for detecting keywords to provide topical suggestions in the creation of new activities.

A computer implemented method in accordance with various embodiments includes a method that captures learning artifacts in hypermedia form. In some embodiments, the method is implemented in a document creation program running on an electronic device, such as the teacher computing device 109, which allows for the creation of activities in an editor-based user interface where the features can be functionally composed with each other. In some embodiments, the method provides a means of storing student activities along with other relevant topical resources in a location that is accessible through a tree structured link. In some such embodiments, such tree structured links are accompanied by a search-ahead feature where the method recognizes the link being typed and auto-completes the link. In some embodiments, activities and resources are tagged with common core standards that allow them to be located at a specific location, where the location contains all activities relating to a specific student as well as the specific common core standard.

In various embodiments, the method incorporates sectional access control lists where only specified persons are able to view and edit specific notes in a document. In some embodiments, the notes come in multiple forms such as, for example, comments, checklists, radio buttons, text entry areas, or the like, and can provide resources and references to other activities via links. In some embodiments, the method allows teachers to assign a same activity to all students in a class and to view every student's answer to the same question in one document.

Various embodiments include a computer implemented method within a document creation program where users create learning artifacts using the document creation program. In some embodiments, activities can either be original or edits, and can be made to a previously created activity. In some embodiments, activities are administered to students and the students can type links, which have an auto-complete feature, within the document to find other activities that they completed or other activities, completed activities, standards, goals, lesson plans, or other learning artifacts with the same common core standards. In some embodiments, students complete activities and return them to the teacher for grading, and sectional access control lists allow specified persons to comment and view comments made on each activity.

In some embodiments, if a teacher wishes to create an activity, the teacher types a link in a document creation program that may be running, for example, on the teacher computing device 109, to search for previously created activities on the same subject. In some such embodiments, the teacher is able to choose a relevant activity and makes any desired edits to the activity based on various factors which can include difficulty, grade level, and goal. In some embodiments, the proposed edits are sharable with a creator of the original document who may accept or reject the edits. In some embodiments, teachers using links to search for previously created activities can see every version of the activity from the original to each edited version and may use any version without adding their own edits.

In various embodiments a teacher can type in a relevant link using, for example, the teacher computing device 109, to find activities that a student completed in other teachers' classes or in other grade levels as a means of getting to know the student and comparing their current performance to their past performance. Also, in some embodiments, the student can type in the relevant link using, for example, the student computing device 108a, to find other activities that they completed and other relevant resources which are tagged with the same common core standards.

Some embodiments allow for the use of sectional access control lists. For example, in some embodiments, a student submits an activity to a teacher for grading, and the teacher can write notes within the document where only specified persons can see the notes. In some embodiments, the teacher can write notes to the student where only the student can see the notes, the teacher can write notes to the parents where only the parents can see the notes, and/or the teacher can write notes within the document where only other teachers can see the notes.

In some embodiments, when a teacher is in the process of creating an activity for a particular subject, the method recognizes a grade level for which the activity is being created and brings up suggestions for questions for the subject based on the subject and grade level. Also, in some embodiments, a teacher is able to administer a same activity to each student via a form and then view every student's response to the same question in one document. In some embodiments, information that consists of original source data rather than derived data is in a unified format, which allows products to interact seamlessly with the each other.

In various embodiments, a parent-only visible checklist includes references to activities and resources. In some embodiments, the checklist is created using composition based features rather than form based features and therefore allows the editor to create sentences. In some embodiments, the visibility of the checklist is restricted only to parents by using sectional access control lists, which may be, for example, lists where the document creator can specify which notes are visible to which individuals. In some embodiments, the checklist includes checkboxes as a widget, which allow the parent to reply to the document creator with a relevant response by clicking a checkbox within the document. In some embodiments, a checklist presented to the patent includes a link that points to an activity recommended by the document creator for the parent to give their child to reinforce a lesson. In some embodiments, the document with the checklist presented to the parent includes an embedded link to provide the parent with an external learning resource.

Various embodiments provide a document structure for creating documents. In some embodiments, when an editor allows students access to a document, a collapsible “Children” section is visible in the document. Also, in some embodiments, different editors can add different sections to the document using different editing programs. In some embodiments when two editors are working on a document, a forward reference is included in the first editor's document that points to the second editor's document and allows users to access the second editor's document while working in the first editor's document. In some such embodiments, the creation of the forward reference in the first editor's document automatically creates a collapse-able backward reference section that contains a link within the second editor's document back to the first editor's document.

A computer-implemented method in accordance with an embodiment allows for integrating educational programs using a document creation system running on an electronic device, such as the teacher computing device 109, where the electronic device includes a memory and a processor that is configured to carry out the method including (1) creating a document within a document creation program that provides an assistance feature; (2) tagging the document with common core standards; (3) tagging the document with a link that stores the document in a specific location; (4) providing users access to the document via a web portal; (5) specifying which areas of the document are viewable by which users; (6) allowing users to make comments within the document; and (7) allowing users to enter links, where the entry of those links is supported by an auto-complete feature, within the document that point to other documents and/or resources. In some embodiments, the document creator is the administrator and a user is granted access to the document by the provision of login credentials.

The construction and arrangement of the systems and methods as shown in the various exemplary embodiments are illustrative only. Many modifications are possible (e.g., variations in sizes, dimensions, structures, shapes, and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using computer processors, or by a special purpose computer processor for an appropriate system, incorporated for this or another purpose, networked systems or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Such machine-readable media includes non-transitory computer-readable media. Combinations of the above are also included within the scope of machine-readable media. Machine-executable instructions include, for example, instructions and data which cause a general purpose computer, special purpose computer, or special purpose processing machines to perform a certain function or group of functions. The machine-executable instructions may be executed on any type of computing device (e.g., computer, laptop, etc.) or may be embedded on any type of electronic device (e.g., a portable storage device such as a flash drive, etc.).

Although the figures may show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

The embodiments disclosed herein are to be considered in all respects as illustrative, and not restrictive of the invention. The present invention is in no way limited to the embodiments described above. Various modifications and changes may be made to the embodiments without departing from the spirit and scope of the invention. Various modifications and changes that come within the meaning and range of equivalency of the claims are intended to be within the scope of the invention.

What is claimed is:

1. A system, comprising:
a recording device including a camera, a processing device, and a storage device;
the processing device configured to process each of a plurality of video files including video data captured by the camera to generate information about which of the plurality of video files satisfy a particular characteristic, and configured to store the plurality of video files in the storage device;
the recording device configured to transmit the information about which of the plurality of video files satisfy the particular characteristic to a computing system, and configured to transmit a particular video file of the plurality of video files in response to a download request for the particular video file.

2. The system of claim 1, wherein each video file of the plurality of video files satisfies the particular characteristic if there is motion in a video of the video file.

3. The system of claim 1, the recording device further comprising:
a second camera and a second processing device for processing video data from the second camera; and
a housing for housing the processing device and the second processing device.

4. The system of claim 1, the recording device further comprising:
a wireless transceiver for receiving wireless signals from one or more wearable devices.

5. The system of claim 4, wherein the recording device is configured to transmit information based on the wireless signals received from the one or more wearable devices to the computing system over a network.

6. The system of claim 4, wherein the recording device is configured to determine a distance from the recording device to each of the one or more wearable devices based on the wireless signals received from the one or more wearable devices.

7. The system of claim 1, the recording device further comprising:
a rotatable mount on which the camera is mounted; and
a microphone mounted on the rotatable mount for providing audio data to the processing device.

8. The system of claim 1, the recording device further comprising:
a second camera and a third camera;
wherein the camera, the second camera, and the third camera are positionable to capture video for at least 174 degrees of area.

9. The system of claim 1, further comprising:
an audio recording device including a printed circuit board, a plurality of microphones connected to the printed circuit board, and a processor connected to the printed circuit board for processing audio data generated from audio signals produced by the plurality of microphones;
the audio recording device configured to provide audio files processed by the processor to the computing system over a network.

10. The system of claim 9, further comprising:
a second audio recording device configured to provide second audio files to the computing system; and
a universal serial bus hub for connecting the audio recording device and the second audio recording device to a computing device.

11. The system of claim 10, further comprising:
the computing system that is configured to track a movement of a person based on the audio files and the second audio files.

12. The system of claim 1, further comprising:
an environment sensor for sensing an environmental parameter related to an environment in which the recording device is located, and for providing information about the environmental parameter to the computing system.

13. The system of claim 1, further comprising:
a plurality of wearable devices that each include a processing device and a wireless transceiver;
the plurality of wearable devices configured to form a mesh network with each other and to transmit signals to the recording device.

14. The system of claim 1, further comprising:
the computing system that is configured to prioritize video files from among the plurality of video files for download based at least partially on the information about which of the plurality of video files satisfy the particular characteristic.

15. The system of claim 14,
wherein the computing system includes a server that is configured to transfer one or more video files to a computing and storage system over a network upon receiving a hypertext transfer protocol POST command from a user device.

16. The system of claim 14,
wherein the computing system is configured to perform facial recognition on a video file received from the recording device to determine an emotional state of individuals in a video of the video file.

17. The system of claim 1,
wherein the processing device is configured to segment the video data captured by the camera into the plurality of video files that are each of a same time length.

18. The system of claim 1,
wherein the processing device is configured to perform facial recognition on each of the plurality of video files and to tag one or more of the plurality of video files based on a result of the facial recognition.

19. A method, comprising:
obtaining video files by a recording device;
generating a video motion list by the recording device indicating which of the video files include videos with motion;
transmitting the video motion list to a server; and
selecting, by the server, one or more of the video files to download from the recording device based at least partially on the video motion list.

20. The method of claim 19, further comprising:
downloading, by the server, the selected one or more video files from the recording device.
